(19) United States
(12) Patent Application Publication
(10) Pub. No.: US 2018/0053149 A1
(43) Pub. Date: Feb. 22, 2018

(54) SYSTEM AND METHOD OF DIRECTING DELIVERY SERVICE REQUESTS, AND A GRAPHICAL USER INTERFACE THEREFOR

(71) Applicants: PAUL SARRAPY, KATY, TX (US); ANDRES CAMACHO, HOUSTON, TX (US)

(72) Inventors: PAUL SARRAPY, KATY, TX (US); ANDRES CAMACHO, HOUSTON, TX (US)

(21) Appl. No.: 15/683,550

(22) Filed: Aug. 22, 2017

Related U.S. Application Data
(60) Provisional application No. 62/377,725, filed on Aug. 22, 2016.

(51) Int. Cl. G06Q 10/08; G06Q 10/06; G06Q 10/10

(52) U.S. Cl. CPC G06Q 10/0834; G01C 21/3407; G06Q 10/1097; G06Q 10/06314

(57) ABSTRACT

Systems, methods, and graphical user interfaces are provided for directing a delivery vehicles loaded with customer packages from an originating point to a destination point. A network of ground ports and roster of ground pilots are established. Each ground pilot is associated with a ground port. Multiple increments of a distance between the originating point and the destination point are determined, with each increment being defined by two pre-existing ground ports. Ground pilots are then selected and directed from the roster of ground pilots to pilot a delivery vehicle between two selected ground ports. Each ground pilots is selected based upon that ground pilot's association with at least one of the two selected ground port. A different ground pilot is selected for each increment until the delivery vehicle arrives at the destination point.

### CROSS-REFERENCE TO RELATED APPLICATIONS

The present application claims the benefit of U.S. Provisional Patent Application No. 62/377,725, filed on Aug. 22, 2016 (pending), the entirety of which is incorporated herein by reference.

### FIELD

The present disclosure relates to systems, methods, and graphical user interfaces for directing a delivery service.

### BACKGROUND

In conventional trucking or ground delivery processes, drivers often take many hours to deliver packages from an origination point to a destination point. Typically a single driver or a pair of drivers operates the delivery truck from the origination point to the destination point. In either case, the driver or drivers remain in the delivery vehicle for the duration of the trip from the origination point to the destination point. Most, if not all, jurisdictions have regulations on the number of continuous hours that a driver can drive (e.g., 10 hours), as well as required intermediate break times in which the driver is not allowed to drive (e.g., 8 hours). Such regulations expand the time required to deliver packages from the origination point to the destination point, affecting both the sender and receiver of the package.

Also, long ground delivery trips affect the drivers, including time at home, health, sleep cycles, and more. Such work schedules affect the available applicant pool for driving in ground delivery processes, as only those available for long-haul driving are apt to accept such jobs.

Some conventional delivery processes are configured for load optimization, such as methods optimized for finding loads and connecting drivers or trucks with loads. However, such systems and methods fail to optimize for drivers of the delivery vehicle in such a way that, for example, allows the drivers to go home each day.

### BRIEF SUMMARY

The present disclosure provides for systems and methods of directing delivery service requests, including managing deliveries, fulfilling deliveries, communicating aspects of deliveries, monitoring deliveries, and more. The present disclosure also provides for systems and methods of logistical communication and\or interface, as well as to an apparatus, graphical user interface, components, and sub-processes therefor. Alternatively, the present disclosure provides for systems and methods of delivery (e.g., ground delivery) utilizing a discrete plurality of delivery assets (e.g., trucking units) from a larger population of candidate delivery assets (e.g., in a serially and continuous fashion) to fulfill a delivery service request. In one aspect, the present disclosure is directed to systems and methods of communications between and\or among service delivery candidates and service issuers. More particularly, in one aspect, the disclosure provides for systems and methods of communicating between service request\issue centers (e.g., company supervisor or administrator or port officers) and a plurality of service delivery candidates. The present disclosure also provides for graphical user interfaces and methods of interfacing for communicating between service request\issue centers and a plurality of service delivery candidates.

In one aspect, the present disclosure provides for a method for directing a delivery service request from an originating point to a destination point. The method entails, for example, utilizing a first ground pilot to pilot a delivery vehicle from point A to point B, and then utilizing a second ground pilot to pilot the same delivery vehicle from point B forward, toward the destination point.

In some aspects, a method is disclosed for fulfilling a client delivery service request from an originating point to a destination point. The method entails a first ground pilot piloting a delivery vehicle from point A to point B, in advancement of a first customer package from an originating point toward a destination point. Then, the first ground pilot pilots a second delivery vehicle from point B to back to point A, thereby advancing a second customer package from point B forward, toward a destination point associated with the second customer package. The present disclosure also provides for systems, graphical user interfaces, and methods (and sub-processes thereof) for, among other things, directing client delivery service request fulfillment.

In some aspects, the present disclosure provides for systems and methods of delivery (e.g., ground delivery) utilizing a discrete plurality of delivery assets (e.g., trucking units) from a larger population of candidate delivery assets (e.g., in a serially and continuous fashion) to fulfill a delivery service request. For example, systems and methods are described for communicating between and\or among service delivery candidates and a service issuer, such as a company supervisor or administrator, with a specific network hub or node responsibility. Some aspects provide for systems and methods of communicating between service request\issue centers (e.g., company supervisor or administrator) and a plurality of service delivery candidates, as well as to graphical user interfaces and methods of interfacing therefor. In a further aspect, the present disclosure provides for software applications for achieving the objects of the systems and methods disclosed herein, including the graphical user interfaces and algorithms presented and/or initiated therewith.

Certain aspects of the present disclosure provide for systems, methods, and graphical user interfaces optimized for ground pilots, using incrementialization and relaying, as opposed to a systems and methods optimized for finding loads and connecting drivers or trucks with loads (load optimization).

In one aspect, the present disclosure provides for a method of directing a delivery service. The method includes establishing a network of ground ports. Each ground port is a physical facility. The method includes establishing a roster of ground pilots. Each ground pilot is associated with at least one of the ground ports. The method includes receiving requests to pilot tucks loaded with customer packages. Each customer package is to be delivered from an originating point to a destination point associated with that customer package. For each customer package and/or delivery vehicle, the method includes determining multiple increments of a distance between the originating point and the destination point of that customer package and/or delivery vehicle. Each increment is defined by two pre-existing ground ports of the established network of ground ports. Each increment may range up to, for example, approximately 250 miles (an estimated 4 hours driving time), allowing drivers to return along the same route (in reverse), thus providing the drivers with an 8 to 9 hour workday. Also, for each customer package and/or delivery vehicle, the method includes selecting and directing a ground pilot from the roster of ground pilots to pilot a delivery vehicle between two selected ground ports. Each ground pilots is selected based upon that ground pilot's association with at least one of the two selected ground ports. In the method, a different ground pilot is selected for each increment until the customer package contained within the delivery vehicle arrives at the destination point.

In certain aspects, the present disclosure provides for a computer-implemented method for directing a delivery service. The computer-implemented method includes providing a computing network including a central computing station associated with and configured for operation by an administrator of the delivery service. The computer-implemented method includes operating a system of communication between the central computing station, a plurality of mobile computing stations, and at least one client computer utilizing the computer network. Operating the system of communication includes presenting graphical user interfaces onto each of the plurality of mobile computing stations, the central computing station, and the at least one client computer. The computer-implemented method includes establishing a network of ground ports, and storing the locations of each ground port on the computer network. Each ground port is a physical facility. The computer-implemented method includes establishing a roster of ground pilots, and storing the roster of ground pilots on the computer network. Each ground pilot is associated with at least one of the ground ports. Each mobile computing station is associated with and configured for operation by one of the ground pilots. The computer-implemented method includes receiving requests on the central computing station from the at least one client computer to pilot delivery vehicles loaded with customer packages. Each customer package is to be delivered from an originating point to a destination point associated with that client package. Each client computer is associated with a client submitting a request to pilot a delivery truck loaded with customer packages. For each customer package and/or delivery vehicle, the computer-implemented method includes using computer instructions stored on the computing network to determine multiple increments of a distance between the originating point and the destination point of that client package. Each increment is defined by two pre-existing ground ports of the established network of ground ports. Also, for each customer package and/or delivery vehicle, the computer-implemented method includes using computer instructions stored on the computing network to select a ground pilot from the roster of ground pilots to pilot a delivery vehicle between two selected ground ports. Each ground pilot is selected based upon that ground pilot's association with at least one of the two selected ground ports. The computer-implemented method includes using computer instructions stored on the computing network to direct the selected ground pilot, via the graphical user interface on that ground pilot's mobile computing station, to pilot a delivery vehicle between two selected ground ports. In the computer-implemented method, a different ground pilot is selected and directed for each increment until the customer package contained within the delivery vehicle arrives at the destination point.

Another aspect of the present disclosure provides for a computer-aided system for directing a delivery service. The system includes a computer network, including a central computing station associated with and configured for operation by an administrator of the delivery service. The system includes a network of ground ports. Each ground port is a physical facility, and the locations of each ground port are stored on the computer network. The system includes a roster of ground pilots, with each ground pilot being associated with at least one of the ground ports. The roster of ground pilots is stored on the computer network. The system includes a plurality of mobile computing stations. Each mobile computing station is associated with and configured for operation by one of the ground pilots, and each mobile computing station is in communication with the central computing station via the computer network. The central computing station is configured to receive and store requests to pilot vehicles for customer package delivery from client computers in communication with the central computing station via the computer network. Each customer package is to be delivered from an originating point to a destination point associated with that client package. Computer instructions are on stored the computer network to present graphical user interfaces onto each of the plurality of mobile computing stations, the central computing station, and the client computers. Computer instructions are stored on the computer network to determine multiple increments of a distance between the originating point and the destination point for each customer package and/or delivery vehicle, with each increment being defined by two pre-existing ground ports of the established network of ground ports. Computer instructions are stored on the computer network to select a ground pilot from the roster of ground pilots to pilot a delivery vehicle between two selected ground ports. Each ground pilot is selected based upon that ground pilot's association with at least one of the two selected ground ports. Also, computer instructions are stored on the computer network to direct the selected ground pilot, via the graphical user interface on that ground pilot's mobile computing station, to pilot a delivery vehicle between two selected ground ports. The system is configured to select and direct a different ground pilot for each increment until the customer package and/or delivery vehicle arrives at the destination point.

Some aspects of the present disclosure provide for graphical user interfaces for use in or with systems or methods for directing a delivery service. The graphical user interfaces includes an administrative graphical user interface configured for directing and monitoring ground pilot delivery of customer packages, a ground pilot graphical user interface configured for receipt of delivery instructions for delivery of customer packages, and a client graphical user interface configured for submission of requests for piloting of delivery vehicles loaded with customer packages.

In some aspects, systems, methods, and graphical user interfaces in which ground pilots, ground ports configured for relay, and associated technology (e.g., software applications and associated graphical user interfaces) are provided. In some such aspects, delivery trucks and any associated customer packages are provided by third parties. As such, a truck delivery company (client), having trucks loaded with customer packages for delivery, may be a client of the delivery service, such that the truck delivery company hires the delivery service to provide ground pilots, ground ports for relay, and the associated technology for implementing the delivery process. In some such aspects, the customer packages are for delivery to customers of the client truck delivery service.

In certain aspects of the present disclosure, the systems, methods, and graphical user interfaces disclosed herein are directed to directing (e.g., managing, overseeing, scheduling, monitoring, controlling, etc.) the piloting of delivery vehicles from an origination point to a destination point, including: (1) establishing a network of ground ports; (2) establishing a roster of ground pilots; (3) for each delivery vehicle, determining multiple increments of a distance between the originating point and the destination point, and selecting and directing a ground pilot from the roster of ground pilots to pilot a delivery vehicle between two selected ground ports. In the methods and systems, a different ground pilot is selected for each increment until the customer package contained within the delivery vehicle arrives at the destination point. Also, the delivery route of each delivery vehicle is coordinated with the delivery route of at least one additional delivery vehicle, such that ground pilots return home along their respective increment (in reverse direction).

The foregoing has outlined rather broadly the features and technical advantages of the present disclosure in order that the detailed description that follows may be better understood. Additional features and advantages will be described hereinafter, which form the subject of the claims. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure. The novel features which are believed to be characteristic of the products, systems, and methods, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings, which are incorporated in and constitute a part of the specification, illustrate aspects, and together with the general description given above and the detailed description of the aspects given below, including the claims that follow, serve to explain the principles of and various aspects of the present disclosure.

FIG. 1A is a simplified schematic of delivery routes with ground ports located along increments thereof;

FIG. 1B is a simplified schematic of a computer network in accordance with certain aspects of the present disclosure;

FIG. 1C is a simplified illustration of a home page\log-in page of a mobile device-based software application, for use by a ground pilot-user, for managing a ground delivery service request, in accordance with certain aspects of the present disclosure;

FIG. 2 is a simplified illustration of an availability information input page of a mobile device-based software application, for use by a ground pilot-user, for managing a ground delivery service request, in accordance with certain aspects of the present disclosure;

FIG. 3 is a screen shot of an exemplary page providing GPS location of route and instructions in a system for managing a ground delivery service request, in accordance with certain aspects of the present disclosure;

FIG. 4 is a simplified illustration of a user-input page of a mobile device-based software application, for use by a ground pilot-user, for inputting incidents and/or delays, in accordance with certain aspects of the present disclosure;

FIG. 5 is a simplified illustration of an electronic logging device page of a mobile device-based software application for managing a ground delivery service request, in accordance with certain aspects of the present disclosure;

FIG. 6 is a simplified flow chart of a method of managing a ground delivery service request using a computing device-based software application, in accordance with certain aspects of the present disclosure;

FIG. 7 is a simplified illustration of screen shots of a user interface web platform of a software application for allowing clients to review, select, and rate pilots, and to purchase pilot services, in accordance with certain aspects of the present disclosure;

FIG. 8 is a simplified illustration of a home page\log-in page of a computing device-based software application, for use by a supervisor\administrator, for managing a ground delivery service request, in accordance with certain aspects of the present disclosure;

FIG. 9 is a simplified illustration of an administration page of a computing device-based software application, for use by a supervisor\administrator, for managing a ground delivery service request, in accordance with certain aspects of the present disclosure;

FIG. 10 is a simplified illustration of an administration page of a mobile device-based software application, for use by a supervisor\administrator, for viewing current pilots and service status, in accordance with certain aspects of the present disclosure;

FIG. 11 is a simplified illustration of an administration page of a mobile device-based software application, for use by a supervisor\administrator, for viewing vehicle inspections, in accordance with certain aspects of the present disclosure;

FIG. 12 is a simplified illustration of an administration page of a mobile device-based software application, for use by a supervisor\administrator, for viewing current departures and arrivals, and coordinating routes, in accordance with certain aspects of the present disclosure;

FIG. 13 is a simplified illustration of an administration page of a mobile device-based software application, for use by a supervisor\administrator, for viewing driver profiles and associated incident reports, in accordance with certain aspects of the present disclosure;

FIG. 14 is a simplified illustration of an administration page of a mobile device-based software application, for use by a supervisor\administrator, for searching for and viewing incident reports, in accordance with certain aspects of the present disclosure; and

FIG. 15 is a simplified illustration of an administration page of a mobile device-based software application, for use by a supervisor\administrator, for rating drivers, in accordance with certain aspects of the present disclosure.

Systems and methods according to present disclosure will now be described more fully with reference to the accompanying drawings, which illustrate various exemplary aspects. Concepts according to the present disclosure may, however, be embodied in many different forms and should not be construed as being limited by the illustrated aspects set forth herein. Rather, these aspects are provided so that this disclosure will be thorough as well as complete and will fully convey the scope of the various concepts to those skilled in the art and the best and preferred modes of practice.

### DETAILED DESCRIPTION

In one aspect, the present disclosure provides for logistics relay systems and methods, and for graphical user interfaces for use therewith. In particular, exemplary systems and methods for directing fulfillment or satisfaction of client delivery requests are provided. In certain aspects, such systems and methods entail communicating with and\or monitoring a roster of ground pilots. The systems and methods may include or be directed to selecting available ground pilots, presenting delivery routes including a plurality of delivery assets (i.e., ground pilots and delivery vehicles) utilized or available to satisfy or realize the delivery route, thereby, fulfilling the delivery service request. In a further aspect, systems and methods are provided to monitor the fulfillment of the delivery service requests, to present the status thereof, and/or to advance the fulfillment of the delivery service requests. In some aspects, most or all of multiple steps are implemented via a computer\electronic network, such as a cloud-based network or other network known to those skilled in the art. Further, handheld devices with supporting mobile applications (apps) downloaded thereon may be used for interacting and communicating via the network, and for carrying out various steps of the methods. In one aspect, a variety of graphical user interfaces are presented on computing device, and are used to implement and/or facilitate steps or sub-processes in the methods disclosed herein. Possible principal actors and/or users of the systems and methods disclosed herein include, but are not limited to, a supervisor or administrator or port officer of the delivery service (e.g., company manager); ground pilots, including candidate ground pilots and active ground pilots; and client(s).

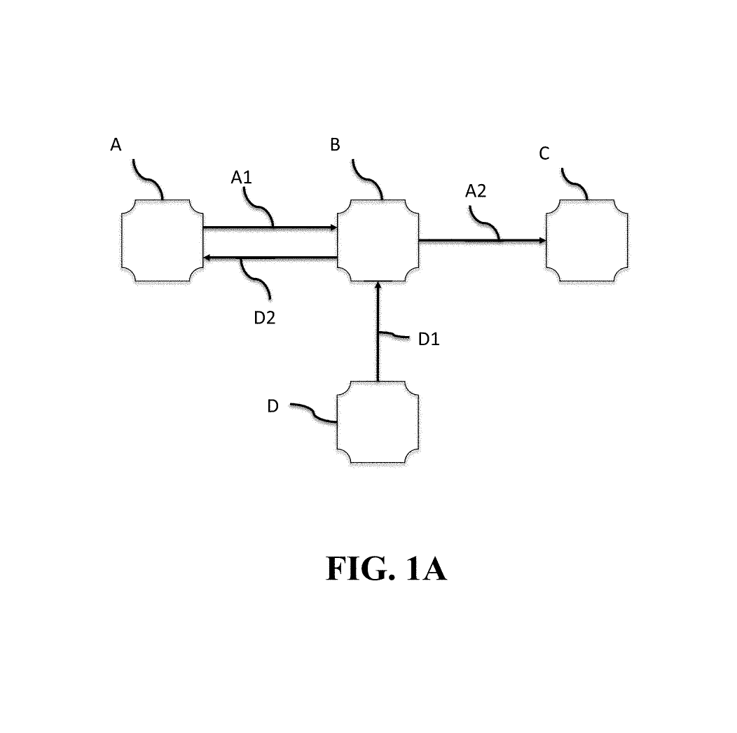

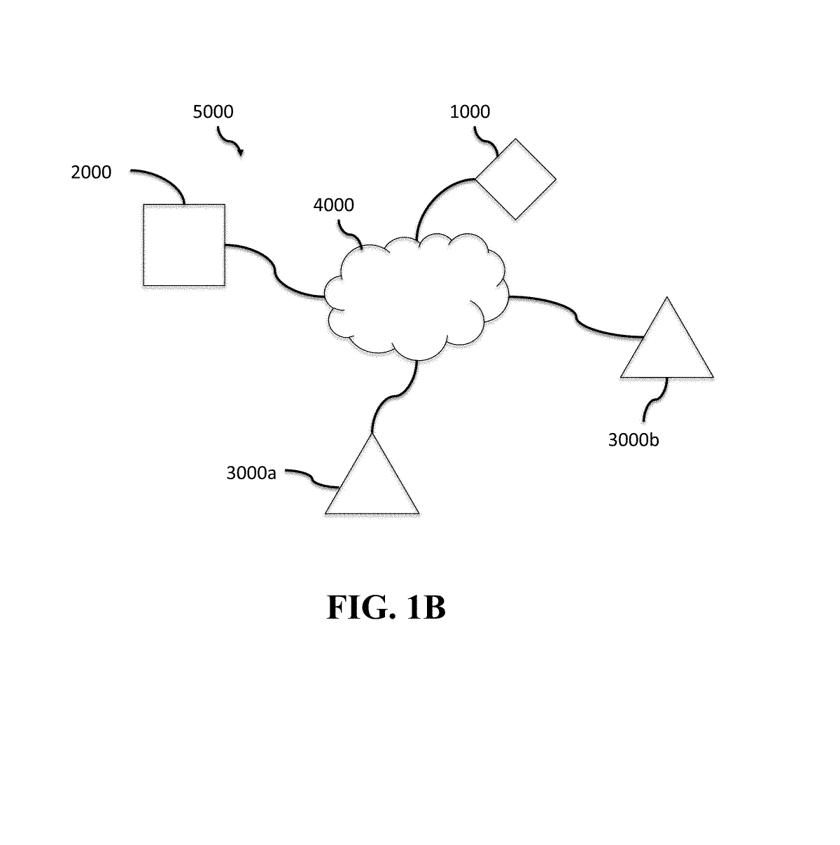

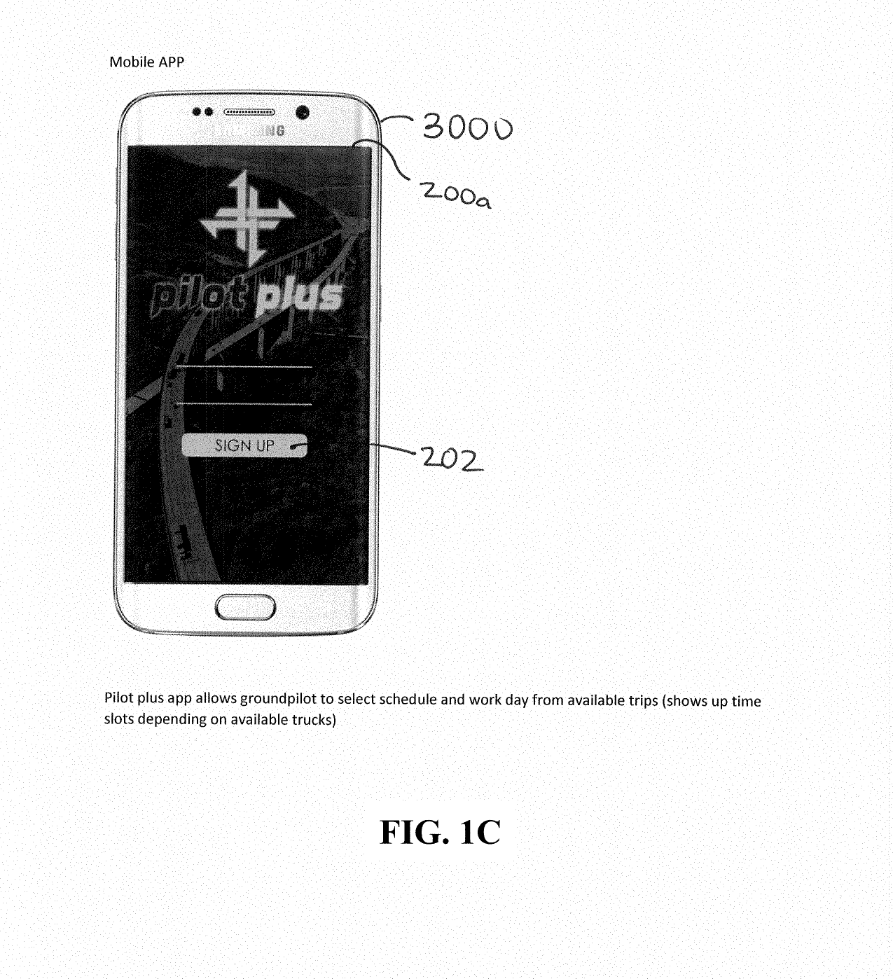

In one exemplary application, a method of ground delivery service entails utilizing a delivery asset combination in the form of a truck and a truck driver (also referred to herein as a ground pilot) to transport a customer package (e.g., product, message, or information) between stages of a defined multi-stage route or itinerary. As shown in FIG. 1A, a first multi-stage route or itinerary includes, increments A1 and A2, together defining a route of delivery for a customer package from point A to point C, with an intermediary point B therebetween. As an example, a ground pilot may drive an estimated 250-mile increment (e.g., approximately 4 hours of driving) from point A to point B (one stage), reaching a facility (also referred to as a ground port or node), whereupon the ground pilot relays the truck to a second ground pilot. The second ground pilot then drives the truck on the defined route, from point B to point C. The original ground pilot that drove the truck from point A to point B may rest at point B, and then return back to point A on a returning truck. The returning truck may be traversing the stage on a different delivery route to satisfy a second, different service request. Alternatively, the returning truck may be traversing the stage on the opposite delivery route from point C to point A. The first driver may act as ground pilot for the increment of driving from point B back to point A, e.g., after a required rest period.

As a result of incrementalization and relaying, some aspects of the presently disclosed delivery systems and methods allow truck drivers (ground pilots) to go home on a daily basis, as they are only traveling on a single increment of a long-haul trip (e.g., an approximately 250 mile, 4 hour long increment in each direction). Spending more time at home can boost driver confidence, health, and energy. Also, having more time at home may result in more and better-rested drivers, thus providing increased safety. Also, as a further result of incrementalization and relaying, some aspects of the presently disclosed delivery systems and methods allow truck drivers (ground pilots) to receive fixed pay checks, as they are capable of driving the same distance on a daily basis. Furthermore, the incrementalization and relaying allows the drivers to select work schedules, and a daily basis. The flexibility provided by such incrementalization and relaying may also may it easier for certain individuals (e.g., stay at home spouses/parents, women, or military veterans) to accept such driving positions, as it is not necessary to be available for the entirety of a long-haul trip, but only for an increment of such a haul (e.g., an 8 hour job, rather than a multi-day job).

As a further result of incrementalization and relaying, delivery trucks may no longer need to stop as frequently, resulting in timelier and efficient package delivery. Furthermore, incrementalization and relaying also, in some aspects, reduces environmental impact of delivery trucks, such as by reducing the need to park the trucks. Often, such parked trucks maintain the air conditioners or heaters on, and refrigerated trucks often leave the engines on to maintain the refrigerant cooling system on. Avoiding or reducing such vehicle stops may reduce the carbon footprint of the delivery service.

For example, per regulations, typical delivery trucks often stop after a driver has driven for 10 hours, as the driver is required to rest for 8 hours until before the driver is allowed to drive again. Incrementalization and relaying reduces or eliminates such stops. As such, products will reach destination points timelier, improving customer service, and reducing client costs by lowering stock necessity. Furthermore, utilization of the systems and methods disclosed herein may allow companies to reduce personnel, focusing on core businesses, rather than expending resources on recruiting delivery truck drivers.

In one aspect, the present disclosure provides for a method of directing a delivery service. The method includes establishing a network of ground ports. With reference to FIG. 1A, exemplary ground points A, B, C, and D are shown. Each ground port is a physical facility configured to allow relay of pilots of delivery trucks. As used herein, a “relay” refers to the transfer of a delivery vehicle from one driver to another driver, such that the vehicle continues along the delivery route, but with a different driver.

The method includes establishing a roster of ground pilots (i.e., truck drivers). Each ground pilot is associated with at least one of the ground ports. For example and without limitation, each ground pilot may be associated with the ground ports near which that ground pilot lives.

The method includes receiving requests to pilot delivery vehicles to deliver customer packages from an originating point to a destination point associated with that customer package. For example, with reference to FIG. 1A, a first request may be to deliver a customer package from point A to point C, and a second request may be to deliver a customer package from point D to point A.

The method includes, for each customer package and/or delivery vehicle, determining multiple increments of a distance between the originating point and the destination point of that customer package and/or delivery vehicle. Each increment is defined by two pre-existing ground ports of the established network of ground ports. The distance of each increment is a predetermined distance that is an increment of the distance between the originating point and the destination point. The predetermined distance of each increment may be a distance (e.g., 250 miles) sufficient to provide ground pilots with the ability to traverse the increment and return along that same increment within the same day (e.g., within an 8 hour work day). For example, for the first request, the multiple increments include increment A1, from point A to point B, and increment A2, from point B to point C. For the second request, the multiple increments includes increment D1, from point D to point B, and increment D2, from point B to point A. In some aspects, the at least two ground ports of each increment are determined based upon ground pilot availability to drive from a first ground port of the at least two ground ports to a second point of the at least two ground ports.

The method includes, for each customer package and/or delivery vehicle, selecting and directing a ground pilot from the roster of ground pilots to pilot a delivery vehicle between two selected ground ports. Each ground pilot is selected based upon that ground pilot's association with at least one of the two selected ground ports. For example, a first ground pilot living at or about point A may be selected and directed to pilot the delivery vehicle from point A to point B. In the method, a different ground pilot is selected for each increment until the customer package contained within the delivery vehicle arrives at the destination point.

In some aspects of the method, the delivery of each customer package is coordinated with the delivery of at least one additional customer package. For example, the delivery of the customer package associated with the first request (point A to point C) may be coordinated with the delivery of the customer package associated with the second request (point D to point A). As used herein, such delivery coordination includes ensuring that, when a first ground pilot drives a first delivery vehicle from point A to point B, for example, then there will subsequently be a delivery vehicle driving from point B to point A, such that the first ground pilot may return to their originating point (here point A). The originating point of the subsequent delivery vehicle may be the same as or different than the first destination point of the first delivery vehicle. Furthermore, the subsequent deliver vehicle may be the same or a different delivery vehicle than the first delivery vehicle. As such, a pilot of the delivery vehicle drives for only one increment of a delivery route, and then drives or rides back to that their origination point. In some aspects, a first ground pilot is utilized to pilot a delivery vehicle from point A to point B, in advancement of a first customer package from a first originating point toward a first destination point, and a second ground pilot is utilized to pilot the delivery vehicle from the point B toward the first destination point, in advancement of the first customer package from the first originating point toward the first destination point. The method includes utilizing a second delivery vehicle to transport the first ground pilot from point B back to point A.

In some aspects, the first ground pilot pilots the second delivery vehicle from point B back to point A. In other aspects, a third ground pilot pilots the second delivery vehicle from point B back to point A. The second delivery vehicle may contains a second customer package, thereby advancing the second customer package from point B toward a second destination point associated with the second customer package (e.g., point A). In some aspects, point A is the first originating point, and point B is a point intermediate of the first originating point and the first destination point (e.g., point C). In some aspects, utilizing the first ground pilot to pilot the delivery vehicle from point A to point B includes directing the first ground pilot to pilot the delivery vehicle from point A to point B, and utilizing the second pilot to pilot the delivery vehicle from the point B toward the destination point includes directing the second ground pilot to pilot the delivery vehicle from point B toward the destination point.

In some aspects, prior to utilizing the first ground pilot to pilot the delivery vehicle from point A to point B, the method includes selecting the first ground pilot from the roster of ground pilots available to pilot delivery vehicles from point A to point B. Also, prior to utilizing the second ground pilot to pilot the delivery vehicle from point B toward the destination point, the method includes selecting the second ground pilot from the roster of ground pilots available to pilot delivery vehicles from point B toward the destination point. Ground pilots selected and directed to pilot the delivery vehicles include client requested ground pilots. Client requests may be for particular ground pilots or for ground pilots based on ground pilot ratings. For example, some aspects of the method include receiving ground pilot availability schedules from ground pilots. For example, the at least two ground ports of each increment may be determined, in part, based upon ground pilot availability to drive from a first ground port of the at least two ground ports to a second point of the at least two ground ports. Ground pilot availability may include days available to work, time frame available to work, total hours per time period available to work, or any other information relevant to availability.

In one aspect, the method disclosed herein, and discussed above with reference to FIG. 1A, is a computer-implemented method for directing a delivery service, utilizing a computer-aided system. With reference to FIG. 1B, the computer-implemented method includes providing computing network 5000, including central computing station 2000 associated with and configured for operation by an administrator of the delivery service. The computer-implemented method includes operating a system of communication between central computing station 2000, a plurality of mobile computing stations 3000a and 3000b, and at least one client computer 1000 utilizing the computer network. For example and without limitation, the computing station 2000, mobile computing stations 3000a and 3000b, and client computer 1000 may be in communication via network 4000, such as a wired and/or wireless communication network. Network 4000 may include, but is not limited to, the Internet, cellular communication networks, satellite-based communication networks, landline based communication networks, or any other communication network well known to those skilled in the art. Each of the computing station 2000, mobile computing stations 3000a and 3000b, and client computer 1000 may be or include desktop computers, servers, laptop computers, mobile communication devices (e.g., mobile phones), tablets, or any other computing device well known to those skilled in the art. Each of the computing station 2000, mobile computing stations 3000a and 3000b, and client computer 1000 may include central processing units, non-transitory data storage, visual display screens, and may be configured to communication with network 4000.

The computer-implemented method includes presenting graphical user interfaces onto each of the plurality of mobile computing stations 3000a and 3000b, central computing station 2000, and client computer 1000. The graphical user interfaces are described in more detail below, with reference to FIGS. 1C-15.

The computer-implemented method includes storing the locations (e.g., GPS location data) of each ground port on computer network 5000. The locations may be stored in the non-transitory data storage of computing station 2000, mobile computing stations 3000a and 3000b, client computer 1000, or combinations thereof.

The computer-implemented method includes storing the roster of ground pilots on computer network 5000. The roster may be stored in the non-transitory data storage of computing station 2000, mobile computing stations 3000a and 3000b, client computer 1000, or combinations thereof.

The computer-implemented method includes receiving requests on central computing station 2000 from the at least one client computer 10000 to deliver customer packages. Each client computer 1000 is associated with a client submitting a request to deliver a customer package and/or pilot a delivery vehicle thereof.

The computer-implemented method includes, for each customer package and/or delivery vehicle, using computer instructions stored on computing network 5000 to determine multiple increments of a distance between the originating point and the destination point of that customer package and/or delivery vehicle. For example, the computer instructions may instruct the central processing unit of the central computing station 2000 to implement an algorithm to determine multiple increments of a distance between the originating point and the destination point of that customer package based upon the available ground ports. As used throughout the present disclosure, any computer instructions and/or any data referred to as being “stored on computing network 500” may include computer instructions and/or data stored in the non-transitory data storage of computing station 2000, mobile computing stations 3000a and 3000b, client computer 1000, or combinations thereof.

The computer-implemented method includes, for each customer package and/or delivery vehicle, using computer instructions stored on the computing network 5000 to select a ground pilot from the roster of ground pilots to pilot a delivery vehicle between two selected ground ports. For example, the computer instructions may instruct the central processing unit of the central computing station 2000 to implement an algorithm to select each ground pilots based upon that ground pilot's association with at least one of the two selected ground ports. In at least some jurisdictions, laws and/or regulations mandate that, in order for a delivery to be released, every single ground pilot must be assigned for that delivery. Thus, in some jurisdictions, if one ground port is still missing a ground pilot, the associated delivery will not be released.

The computer-implemented method includes, for each customer package and/or delivery vehicle, using computer instructions stored on the computing network 5000 to direct the selected ground pilot, via the graphical user interface on that ground pilot's mobile computing station, to pilot a delivery vehicle between two selected ground ports. For example, the computer instructions may instruct the central processing unit of the central computing station 2000 to transmit a message to a selected ground pilot's mobile computing station instructing that ground pilot to pilot a delivery vehicle along a particular increment of a delivery route. Such a message may be presented on the graphical user interface of that ground pilot's mobile computing station.

In some aspects, the computer-implemented method includes using a scheduling algorithm stored on computer network 5000 to determine a logistical delivery schedule to coordinate the delivery of each customer package and each delivery vehicle. For example, the computer instructions may instruct the central processing unit of the central computing station 2000 to implement a scheduling algorithm that coordinates the delivery vehicles, and/or the delivery of each customer package with delivery of at least one additional customer package. The scheduling algorithm may coordinates the delivery of a first customer package from a first originating point to a first destination point with delivery of the at least one additional customer package from a second originating point to the first originating point. The scheduling algorithm may coordinate the delivery of each customer package with delivery of at least one additional customer package such that each ground pilot is returned to that ground pilot's originating point on at least one additional delivery vehicle.

In one aspect, the scheduling algorithm is programmed to optimize for the free flow of products via the delivery service. For example, give two delivery trucks (Delivery Truck A and Delivery Truck B), the scheduling algorithm functions to coordinate the departure times for Delivery Truck A and delivery Truck B, such that both delivery trucks depart at certain predetermined times that arranges for each ground pilot a trip back home on one of the delivery trucks, on a daily basis. For example, a Delivery Truck A may depart from a first ground port at 10:00 AM, and arrive at a second ground port at 2:00 PM. In such situation, the scheduling algorithm may coordinate the route and timing of Delivery Truck B, such that Delivery Truck B arrives at the second ground port at, for example, 2:30 PM, allowing the ground pilot of Delivery Truck A to return home on Delivery Truck B. In some aspects, each delivery truck registered in the computer network by a customer is automatically accounted for by the scheduling algorithm and considered by the scheduling algorithm during determination of the logistical delivery schedules for each ground pilot. In some aspects, in determining the logistical delivery schedules, the scheduling algorithm accounts for current or expected traffic, current or expected weather, and other factors that affect the delivery route, including any incidents that may arise during and/or along the delivery route.

In certain aspects, the scheduling algorithm is stored on the central computing station 2000 (e.g., located at an administrative hub) remote from the mobile computing stations of the ground pilots, remote from the client computers, remote from the ground ports, or combinations thereof. The scheduling algorithm may be configured to ensure and/or verify that each individual ground pilot is provided with transportation back to a first point (e.g., home or proximate home) after piloting a delivery vehicle from the first point in a second point, such as by coordinating another delivery vehicle for the ground pilot to ride in or drive. In some aspects, the scheduling algorithm only schedules delivery routes that incrementally connect ground ports within the network of ground ports, such that each increment (in one direction) scheduled by the scheduling algorithm is no more than approximately 250 miles and/or approximately no more than 4 hours of driving time. Thus, all delivery routes in the logistical delivery schedule traverse only along routes that incrementally connect ground ports within the existing, established network of ground ports. As such, each delivery route in linked to (i.e., required to intersect) multiple ground ports in the network of preexisting, established ground ports, and no delivery route includes an increment that is greater than the predetermined limit (e.g., 250 miles in one direction and/or 4 hours driving time in one direction). In some instances, delivery routes scheduled by the scheduling algorithm are different than delivery routes not linked to the network of ground ports, as such unlinked delivery routes are not required to pass through any of the preexisting, established ground ports. While, in some such instances, the overall delivery route from the origination point to the destination point is of a longer distance than if the delivery route proceeded via a path not limited to paths intersecting ground ports within the existing, established network of ground ports, the distance that each ground pilot is required to drive remains the same. The overall delivery time, using the scheduling algorithm and the network of ground ports, may be less, as the delivery vehicle is not required to stop for driver rest (e.g., per law or regulation). For example, with reference to FIG. 1A, a straight-line path, along a roadway, from point A to point D may be available as a delivery route, and such a delivery route may be a shorter overall distance than a delivery route that passes from point A to point B, then to point D. Also, such a delivery route may be longer than increment A1 (e.g., longer than 250 miles and/or longer than a 4 hour drive time). As such, a ground pilot piloting a delivery vehicle along such a straight-line path, which is not within the network of ground ports, may be forced to stop and rest at least once, per regulations, along the straight-line route back and forth between point A and point D. However, by only scheduling delivery routes that incrementally connect ground ports within the network of ground ports, each pilot involved in the delivery is ensured the ability to complete a round trip along an increment within a day (e.g., within 8 hours), such that the ground pilot can go home each day without exceeding regulated driving limits.

In some aspects, the scheduling algorithm is configured to optimize the logistical delivery schedule for the ground pilots, such that the ground pilot can go home each day without exceeding regulated driving limits, thus improving quality of life through the use of incrementalization and relaying, as opposed to optimizing load by ensuring that the delivery vehicles are not empty along any route of travel. As such, in some aspects, the scheduling algorithm forms a logistical delivery schedule that includes delivery routes of delivery vehicles (e.g., trucks) that are empty of customer packages. For example, with reference to FIG. 1A, a delivery vehicle may traverse increments D1 and D2 without any customer packages contained therein, for the purpose of providing a delivery vehicle to a ground pilot resting at point B, such that that ground pilot can be transported back to point A. Also, in some aspects, the scheduling algorithm forms a logistical delivery schedule that directs delivery vehicles to travel through ground ports that are unnecessary for the delivery of customer packages contained thereon. For example, with reference to FIG. 1A, a delivery vehicle may be directed to traverse increments D1 and D2 for the purpose of providing a delivery vehicle to a ground pilot resting at point B for transport back to point A, even if the delivery vehicle is capable of traversing through a different series of ground ports that would provide that delivery vehicle with a shorter pathway between the origination point and the destination point.

In some aspects, the computer-implemented method includes receiving and storing ground pilot availability schedules on computer network 5000 from the plurality of mobile computing stations 3000a and 3000b. For example, the graphical user interfaces on the plurality of mobile computing stations 3000a and 3000b may allow ground pilots to input availability schedules, which may be transmitted via network 4000 to central computing station 2000. In some aspects, the computer-implemented method includes using computer instructions stored on computer network 5000 to determine the at least two ground ports of each increment based upon the stored ground pilot availability schedules, including ground pilot availability to drive from a first ground port of the at least two ground ports to a second point of the at least two ground ports. For example, the computer instructions may instruct the central processing unit of the central computing station 2000 to implement an algorithm to select ground ports along the delivery route from the origination point to the destination point based, at least in part, upon ground ports associated with available ground pilots. In some aspects, the graphical user interface on each of the plurality of mobile computers 3000a and 3000b is configured to allow the ground pilots to form an availability schedule by selecting when they are available for piloting delivery vehicles, which point or points they are available to deliver packages to, which point or points they are available to deliver packages from, or combinations thereof.

In some aspects, the graphical user interface on each of the plurality of mobile computers 3000a and 30000b is configured to allow the ground pilots to report incidents to the administrator, such as via input of incident reports. Input incident reports may then be stored on the computer network 5000. Such incident reports may include reports of stopping the delivery vehicle to get gasoline, stopping the delivery vehicle to eat lunch, an automobile accident, the delivery vehicle being pulled over by law enforcement, a mechanical failure of the delivery vehicle, a road block, a tire or wheel failure on the delivery vehicle, or a traffic incident.

In some embodiments, in determining the logistical delivery schedules, the scheduling algorithm dynamically modifies the logistical delivery schedules (e.g., in real-time), to account for delays (e.g., unexpected delays). For example, with reference to FIG. 1A, a first ground pilot that drove the first delivery vehicle along increment A1, from point A to point B, may be expected to return home on increment D1 via a second delivery truck traveling from point D to point A, via point C. However, if the second delivery truck has an incident (e.g., a mechanical failure) this may prevent the first ground pilot from being able to return home on the second delivery truck. In such a situation, upon report of the incident via the driver of the second delivery vehicle, the scheduling algorithm may modify the logistical delivery schedule to provide the first driver with a ride home. For example, the scheduling algorithm may modify the logistical delivery schedule, such as by scheduling another delivery vehicle from, for example, point B bring the first ground pilot back home.

In some aspects, the graphical user interface on each of the plurality of mobile computers 3000a and 3000b is configured to present an electronic log associated with the delivery vehicle. The electronic log is stored on the computer network 5000, and is viewable by the administrator via the graphical user interface of the central computing station 2000. In certain aspects, the graphical user interface on each of the plurality of mobile computers 3000a and 3000b is configured to allow for the sharing of the electronic logs, such as via email, BLUETOOTH®, text, WI-FI®, or other method known to those skilled in the art.

In certain aspects, the graphical user interface on central computing station 2000 is configured to all the administrator to track all delivery vehicles, mobile computing stations 3000a and 3000b, or combinations thereof in communication with the computer network 5000. For example and without limitation, each delivery vehicle may be tracked via GPS transmitters or the like, which may transmit GPS location data to central computing station 2000 via network 4000. Also, each mobile computing station 3000a and 3000b may be tracked via GPS or the like, which may transmit GPS location data to central computing station 2000 via network 4000. As such, the graphical user interface on the central computing station 2000 may be configured to all the administrator to track a status of all package deliveries. Such GPS enabled tracking, in some aspects, allows for clients and administrators to view, in real-time (e.g., via a live feed of GPS data), the status of deliveries along the delivery route.

In some aspects, after each increment that each delivery vehicle is piloted through, a vehicle inspection is performed on that delivery vehicle. The graphical user interface on each mobile computing station 3000a and 3000b is configured to allow the ground pilot to complete and upload a vehicle inspection report onto computer network 5000, and the graphical user interface on central computing station 2000 is configured to present to each uploaded vehicle inspection report. Such vehicle inspection reports may also be viewable by a client via the computer network 5000 and on the graphical user interface of that the client computer 1000. In some embodiments, vehicle inspections are recorded onto the computer network 5000 in real-time, as the inspections occur at each relay location. In some aspects, both ground pilots and port officers sign off on forms that provide agreement between all parties, with regards to the vehicle inspection.

The graphical user interface on the central computing station 2000 may also be configured to allow the administrator to submit a review each ground pilot, rate each ground pilot, or combinations thereof. Such reviews, ratings, or combinations thereof are stored on the computer network 5000.

Certain aspects of the present disclosure include graphical user interfaces for use in or with the systems or methods disclosed herein. The graphical user interfaces include an administrative graphical user interface configured for directing and monitoring ground pilot delivery of customer packages, a ground pilot graphical user interface configured for receipt of delivery instructions for delivery of customer packages, a client graphical user interface configured for submission of requests for delivery of customer packages, or combinations thereof. The software for use of the computer-aided system and/or implementation of the computer-implemented method, and for presentation of the associated graphical user interfaces may be downloaded onto the central computing station, mobile computation stations, and/or client computers, such as in the form of a mobile application (app).

FIGS. 1C-15 illustrate such graphical user interfaces, in accordance with certain aspects of the present disclosure.

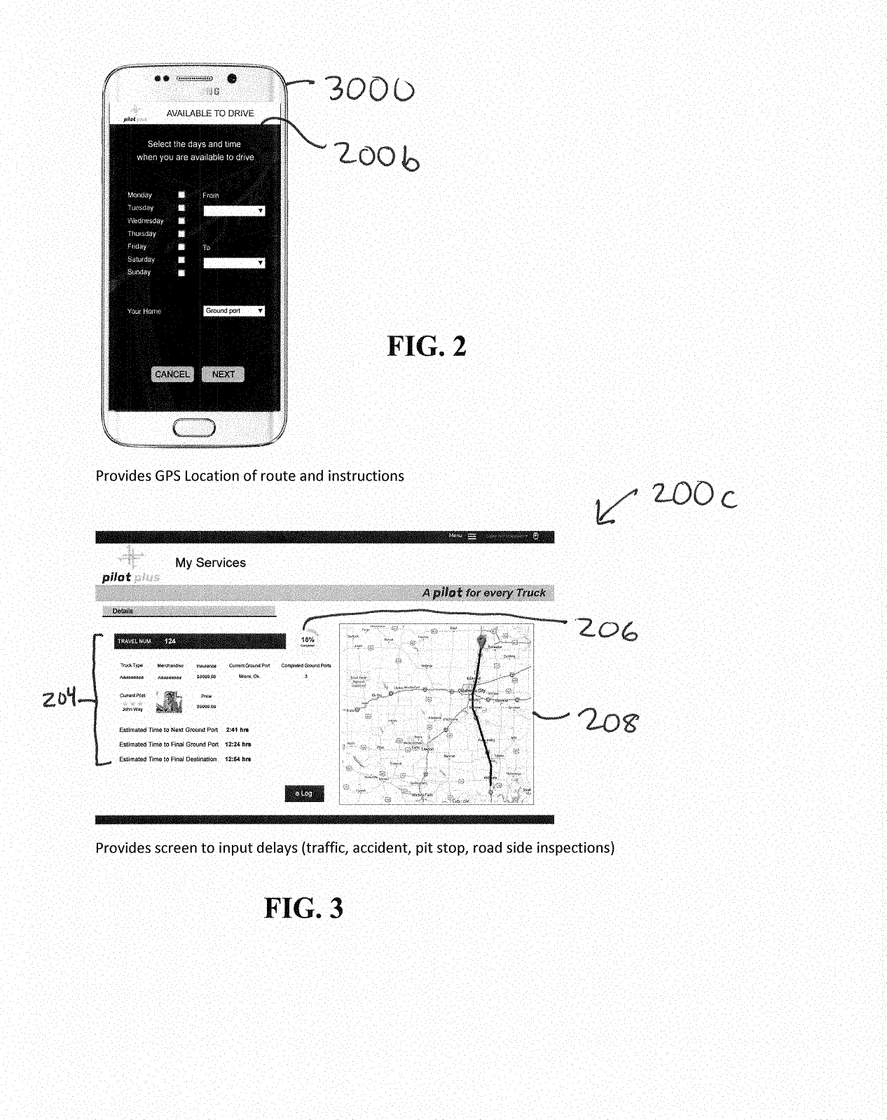

FIGS. 1C and 2 provide interactive application pages, a ground pilot graphical user interface, for an exemplary mobile application. FIG. 1C depicts mobile computing station 3000 presenting graphical user interface (GUI) 200a. GUI 200a present a page configured to allow a ground pilot to sign-in and/or sign-up to be an available ground pilot, utilizing sign-up button 202. FIG. 2 depicts graphical user interface 200b, presenting a page configured to allow ground pilots to select availability schedules, including available workdays and times and ground ports. The graphical user interface 200b may then present available time slots and trucks from which the ground pilots may select an available time slot, depending upon the available trucks and deliveries from the relevant ground port. Graphical user interface 200b may present pages that reflect actions by the user, a candidate pilot, to input delivery asset information into the system and computer network. By entering personnel and availability data into the computer network, the user may input required delivery asset data into the system and computer network. The graphical user interface 200b provides, for example, information determining the availability of the candidate pilot (time and date) as a ground pilot from or at a particular origination point, a home ground port from which a delivery vehicle (and customer package) may arrive and originate. Such information may then be used to match (and satisfy) a client delivery service request to a candidate fulfillment itinerary, including route, schedule, and ground pilot information.

FIG. 3 depicts a screen shot of an exemplary page of a graphical user interface 200c for use and view by one or more users of the system. Graphical user interface 2000c may be used to confirm the parameters for fulfilling a client delivery service request (i.e., a customer's package delivery) including a status of the client delivery service request. In FIG. 3, a certain customer merchandise (package) is shown to be in the physical custody of a ground pilot piloting a truck between ground ports or nodes in a defined delivery route or itinerary. Graphical user interface 200c presents client, package, route, and ground pilot information 204, which may include, but is not limited to: truck type, merchandise identification, insurance value, current ground port location, completed ground ports, current ground pilot, ground pilot rating, ground pilot photograph, price for delivery, estimated time to next ground port, estimated time to final ground port, and estimated time to final destination point. The ground pilot information 204 may include defined route information, delivery asset information (e.g., truck and driver information). Graphical user interface 200c may present a graphical indicator 206 of percent completion of customer package delivery, and a map 208 of the delivery route or a portion thereof. Map 208 may provide the GPS location of the delivery vehicle and/or route, as well as directional instructions.

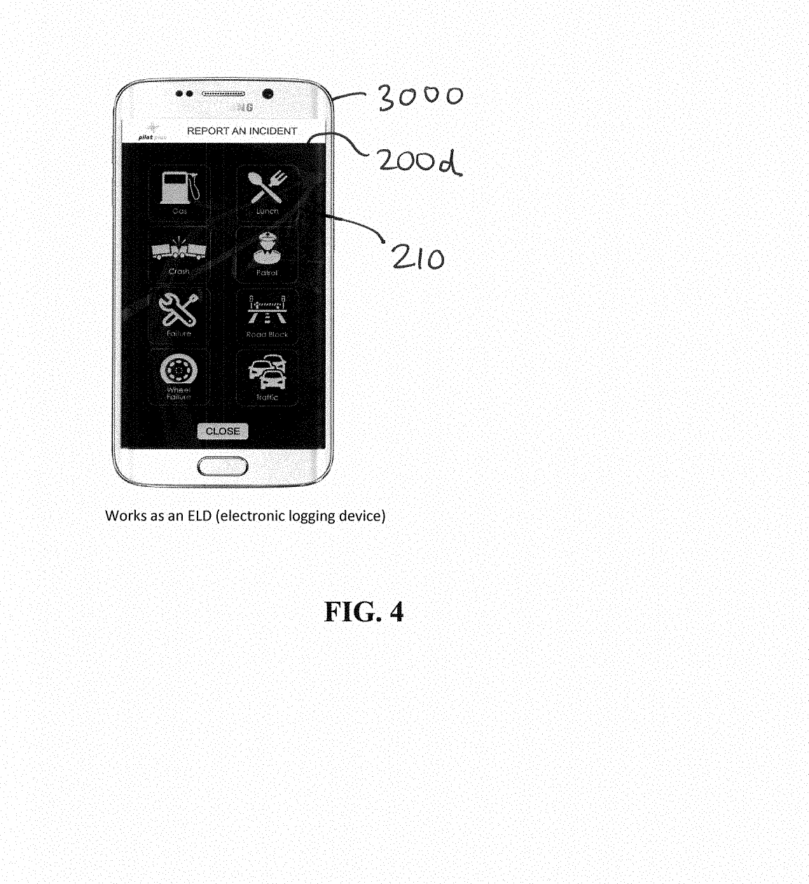

With reference to FIG. 4, graphical user interface 200d may be used by the supervisor\administrator\port officer, ground pilot, or other personnel to input current information, including delays, traffic information, and the like. As such, mobile computing stating 3000 may function as an electronic logging device for an active ground pilot. As shown, graphical user interface 200d presents the user with a menu of incident selections 210, for touch-ready activation by the user. The incident selections 210 include, but are not limited to: stopping the delivery vehicle to get gas or eat lunch or other pit stops; a car accident, road block, or other traffic incident; stopping the delivery vehicle as a result of being pulled over by law enforcement; the occurrence of a vehicle (e.g., mechanical) failure or a wheel/tire failure; and roadside inspections.

In some aspects, the ground pilot graphical user interface may be configured to allow for voice-commands (e.g., for reporting incidents), which is safer for operation by the ground pilot during driving of the delivery vehicles. In some such embodiments, the physical buttons and/or touch screen of the ground pilot graphical user interface is configured to only be available for use when the associated delivery vehicle is parked and/or not moving.

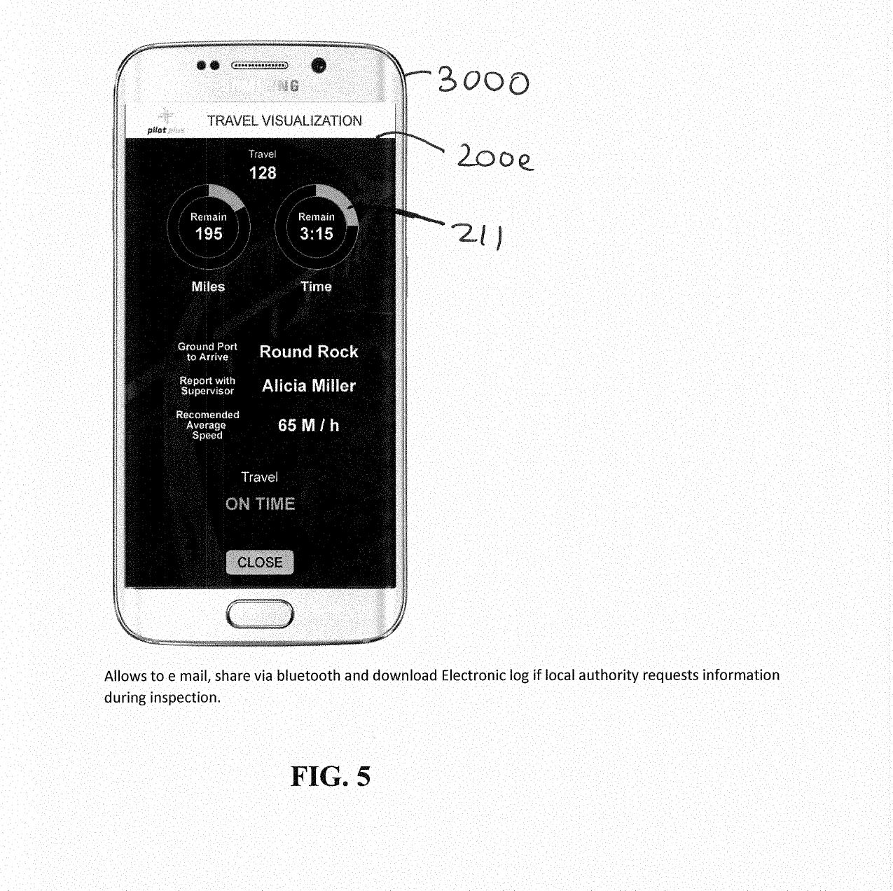

In some aspects, the present disclosure presents exemplary mobile application pages and\or graphical user interfaces for use by a ground pilot or delivery asset, and which enhances or improves the system and method of fulfilling a client's ground delivery request. With reference to FIG. 5, graphical user interface 200e presents an electronic log 211, such that mobile computing device 3000 functions as an electronic logging device (ELD). Electronic log 211 may be useful for logging information that may be presented to inspection authorities, for example. Further, the electronic log 211 information may be communicated via e-mail, BLUETOOTH® and\or downloaded from the mobile computing device 3000 (e.g., handheld device), such as to a local authority requesting the information during inspection. The electronic log 211 information may include, but is not limited to: miles remaining, time remaining, travel number, ground port arrival destination, ground pilot's supervisor's name, recommended average speed, and an indication of whether or not the delivery vehicle is on time. In some aspects, the electronic log is viewable (optionally at all times) by clients on the client graphical user interface.

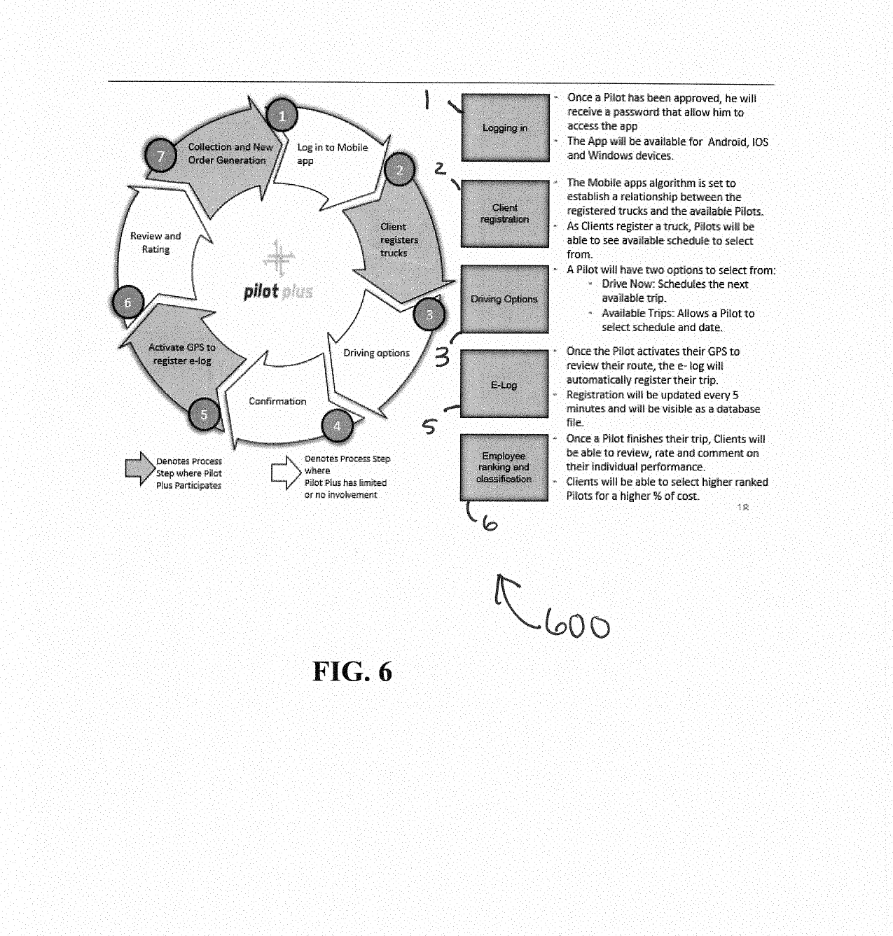

FIG. 6 illustrates a method of interacting with or communicating between principal actors/users within the system and computer network, in accordance with certain aspects of the present disclosure. In interaction 600 involves communication and/or interaction via a computing device, such as a mobile device, other handheld device, laptop, or desktop computing device, as well as use of a software application that presents graphical user interfaces thereon. The software application may include a mobile application appropriate for use by a ground pilot, and a mobile application appropriate for use by a client. In some aspects, the mobile applications include programmable computer instructions stored on non-transitory data storages on local computing stations (client computer and/or mobile computing stations) or on a cloud network accessible by such local computing stations. Such programmable computer instructions include run algorithms that may be initiated from the handheld device and\or various graphical user interfaces disclosed herein. In the application of interaction 600, the principal actors include the ground pilot(s), the client (s), and the company or supervisor of the delivery service. As illustrated in FIG. 6, several user steps may be implemented via a mobile application page and graphical user interface.

1. A first step of interaction 600 includes step 1, logging-in to the mobile application. A ground pilot or prospective ground pilot may download the mobile software application onto a device (e.g., mobile phone) and log-in to the system or computer network. In step 1, a ground pilot is approved and given a password that allows that ground pilot to access the mobile application. Upon approval or authorization by an administrator, the ground pilot may input availability information via the ground pilot graphical user interface, such as is shown in FIGS. 1C and 2. The ground pilot may then be added to the roster of available ground pilots, and further, may be associated to at least one ground port based on diver-user input information (e.g., where the ground pilot lives).

In step 2, clients register deliver trucks in the system or computer network. For example, an algorithm run on or by the mobile application establishes a relationship between registered trucks\delivery vehicles and available ground pilots. In some aspects, as a client registers a truck or vehicle, ground pilots are able to see available schedules (delivery routes) to choose from.

In step 3, ground pilots select driving options. For example, an available ground pilot logged-on to the system or computer network may be presented with two options, including: (1) drive now; and (2) available trips. If a ground pilot selects “drive now”, the system/computer network schedules the ground pilot to pilot the next available delivery vehicle on the next available trip from that ground pilot's associated ground port. If a ground pilot selects “available trips”, the ground pilot is presented with a graphical user interface allowing the ground pilot to select a schedule and date for piloting delivery vehicles.

In step 4, confirmation of a trip occurs via a system initiated trip registration. The system/computer network operates to confirm the trip, including matching of the ground pilot with trips or stages of a route or schedule, and setting of delivery service parameters.

In step 5, ground pilot GPS is activated and an electronic log (e-log) is registered. The GPS activation may include initiating the sharing of the GPS location of the mobile computing station 3000, of the delivery vehicle, or both. For example, the ground pilot graphical user interface may a button that initiates the sharing of the mobile computer station GPS location data with the central computing station via the communications network. The system/computer network may then operate to monitor trips and monitor the fulfillment of delivery service requests through the various stages of the itinerary, including at the ground ports. Typically, once a ground pilot activates GPS location to review the route, for example, the e-log automatically registers the trip. In some aspects, the registration will be updated every five minutes and is visible as a database file stored on the computer network. In some aspects, activating GPS tracking and monitoring also initiates (e.g., turns on) operation of GPS cameras on the delivery vehicle. Such GPS cameras may be configured to automatically record the roadway adjacent the delivery vehicle along the delivery route during operation of the vehicle. The recorded video of the GPS cameras may be viewable on the administrative graphical user interface, the client graphical user interface, the ground pilot graphical user interface, or combinations thereof. As such, the systems, methods, and graphical user interfaces disclosed herein allow for real-time visualization of the delivery process.

In step 6, reviews and ratings are obtained, such as via post-trip client input from the client computer, using the client GUI. Once a ground pilot completes a trip, the client is able to review, rate, and comment on the ground pilot's performance. In some aspects, clients are able to review ground pilot data, and may select ground pilots based on that data, including selection of higher ranked ground pilots, which may cost more than lower ranked ground pilots.

Step 7 includes collection of payment from the client, as well as the generation of new orders for customer package delivery.

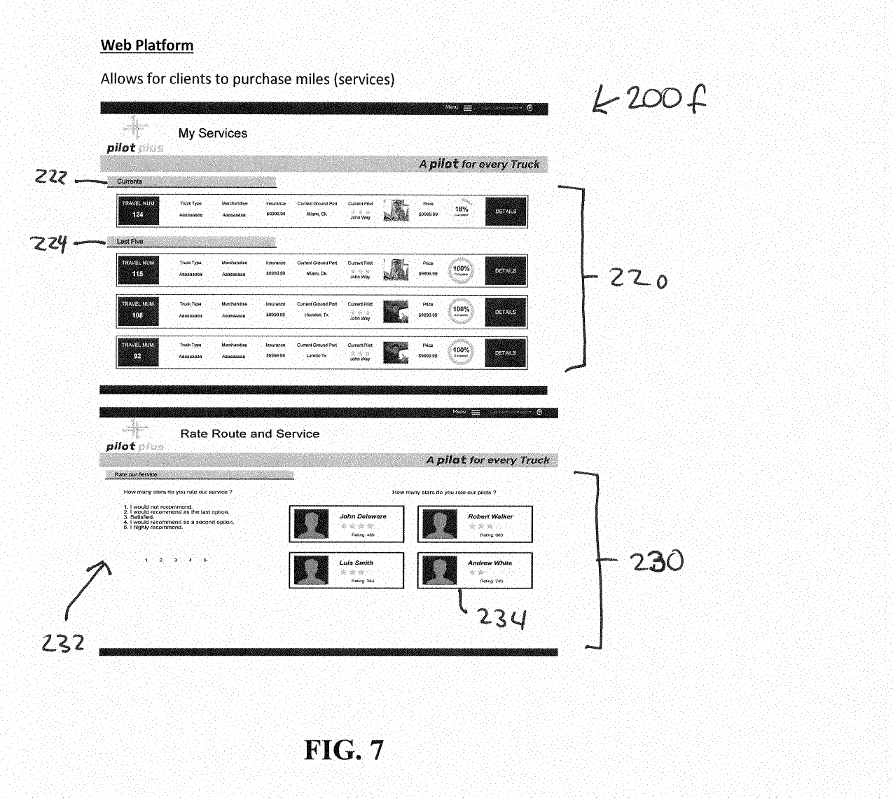

FIG. 7 depicts an exemplary web page(s) for use by a client associated with the system/computer network for managing client delivery requests. Graphical user interface 200f may present a client services information 220, including information regarding current customer package deliveries 222, and information regarding prior customer package deliveries 224. Each of information 222 and 224 includes, but is not limited to: a travel number, truck type, merchandise identification, insurance value, current ground port, current ground pilot (including rating and photograph), price, and percent completion. One skilled in the art would understand that the system, method, and GUI is not limited to the particular information shown and described in FIG. 7, and may include any relevant information, depending upon the particular application.

Graphical user interface 200f may also present a rating page 230 for rating the delivery route and delivery services. For example, graphical user interface 200f may present questions 232 about the delivery service, allowing the client to rate the delivery service. Also, graphical user interface 200f may present questions 234 about the ground pilot, allowing the client to rate and/or review the ground pilot.

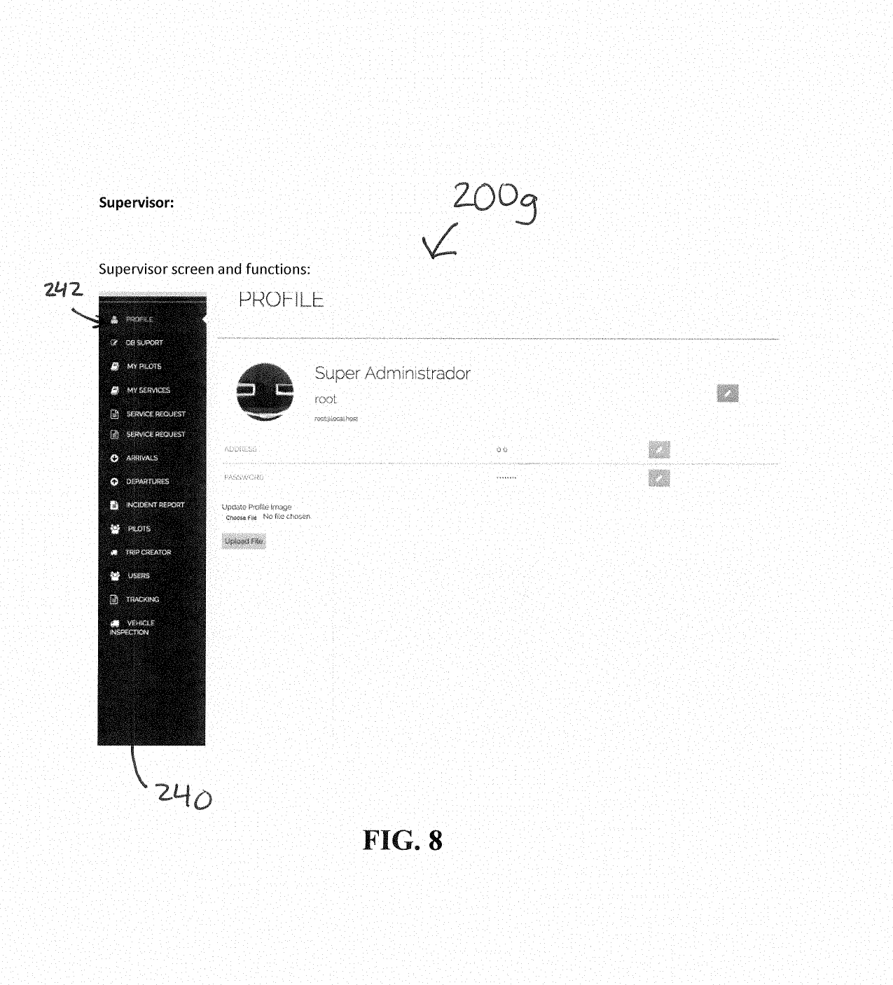

FIGS. 8-10 depict exemplary web pages for use by a supervisor and\or other company personnel (administrator) associated with the system/computer network. With reference to FIG. 8, graphical user interface 200g includes side panel menu 240. Side panel 240 includes various tabs that allow the administrator to select the information to be presented in the administrative graphical user interface. In FIG. 8, the profile tab 242 is selected, such that graphical user interface 200g presents a profile of the administrator logged-in to the central computing station. The administrative graphical user interface is configured to convey information on the population of active client delivery service requests, delivery assets including candidate pilots and delivery vehicles, and historical information, and the like. The administrative graphical user interface may be configured to allow the administrator/supervisor to view all such information in the form of reports, tables, graphs, or any other of various forms of presenting information known to those skilled in the art.

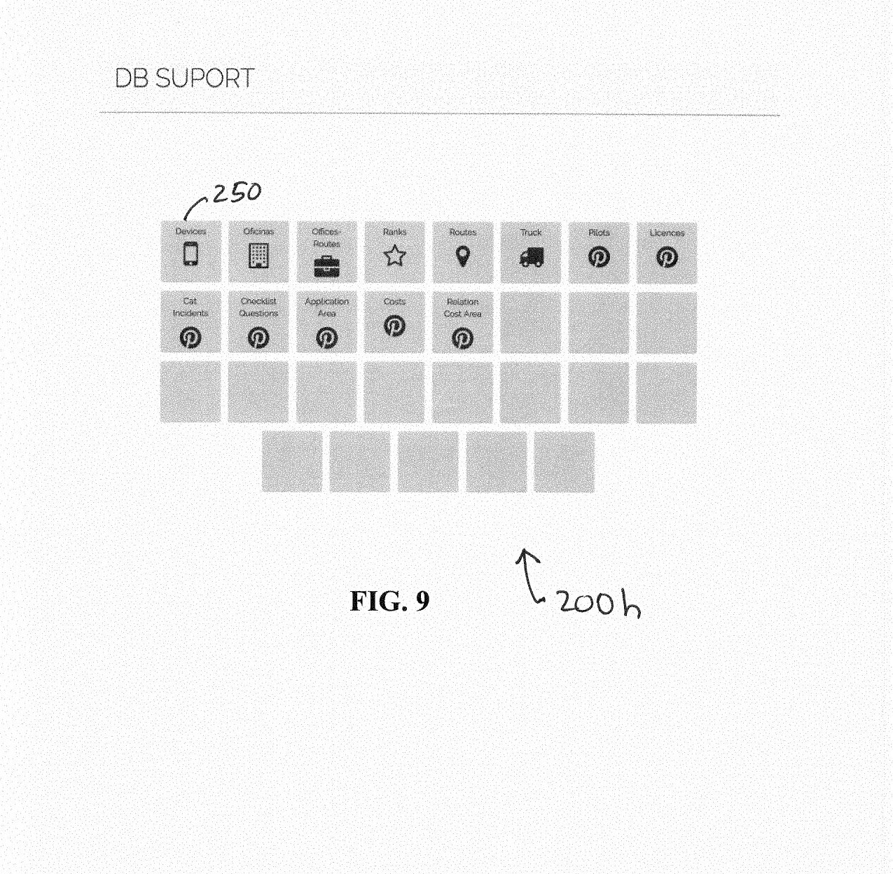

FIG. 9 depicts graphical user interface 200h, when the “DB Support” tab of side panel menu 240 is selected. Graphical user interface 200h allowed the administrator to select and view information 250 regarding: mobile computing devices connected to the computer network, ground ports, delivery routes, ratings of the service and ground pilots, delivery vehicles, ground pilots, licenses, incident reports, and various other information. As would be understood by one skilled in the art, graphical user interface 200h can be configured to present any desired and available information, and is not limited to the information shown and described with respect to FIG. 9.

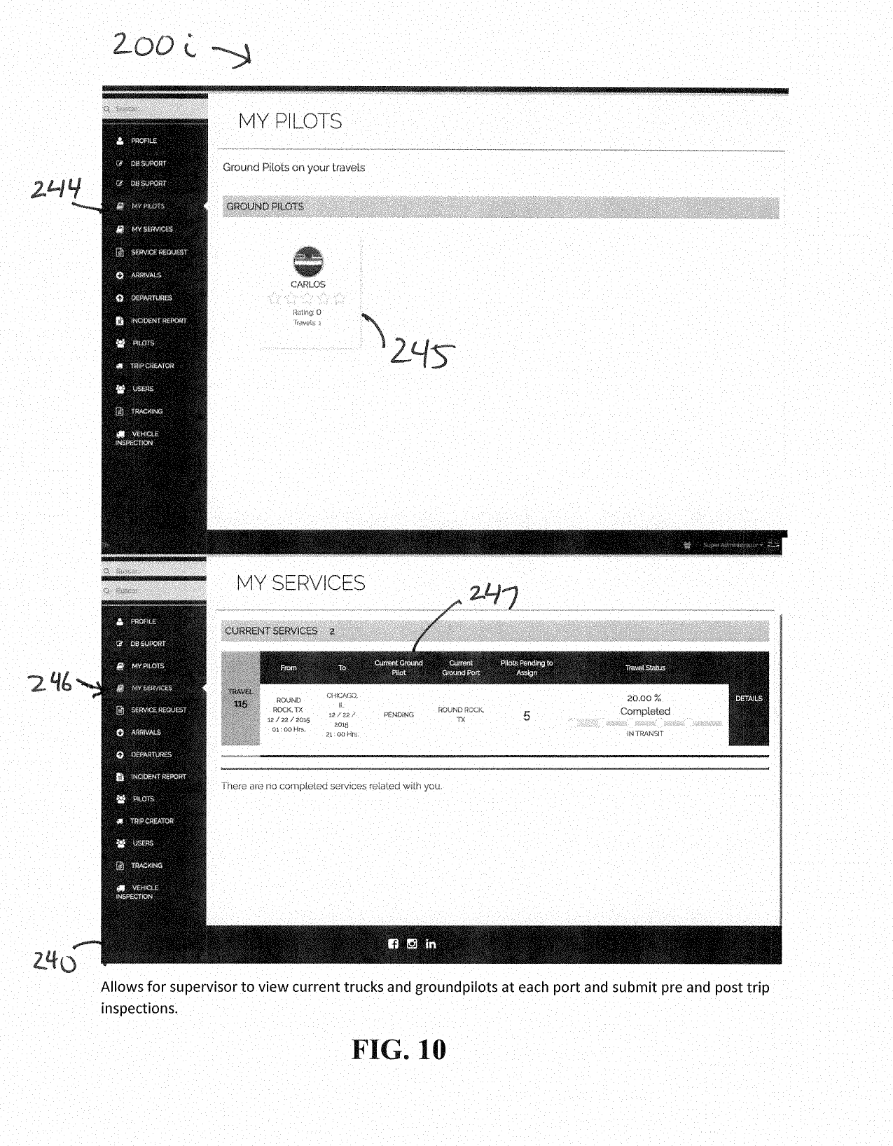

FIG. 10 depicts graphical user interface 200i, simultaneously presenting information associated with the “my pilots” tab 244 and the “my services” tab 246. The “my pilots” tab 244 may allow the administrator to rate and/or review ground pilots, such as by using rating interface 245. The “my services” tab 246 is configured to allow the administrator to view delivery service, including current delivery services. Deliver services information 247 may include, but is not limited to: travel number, origination point, destination point, current ground pilot, current ground port, pilots pending to be assigned, and travel status.

Other tabs available for selection using the side panel menu 240 include, but are not limited to: a service requests to view service requests, an arrivals tab to view all arrivals, a departures tab to view all departures, an incident report tab to view incident reports, a pilots tab to view ground pilots, a trip creator tab to create a delivery route, a users tab to view and/or manage all users, a tracking tab to track package delivery, and a vehicle inspection tab to view vehicle inspections. As such, administrators, using the administrative graphical user interface, are capable of viewing the roster of pilots and pilot information, and the status of current client delivery service requests. In this example, the administrator is charged and designated a ground port, and the system relates delivery assets, as well as vehicle and ground pilots, to that central ground port, at least in respect to the administrator as a user of the system. Accordingly, the administrator may manage the delivery assets, and act upon the various active and pending or potential client delivery service requests from his\her ground port perspective. For example, an administrator may coordinate routes at or from the ground port of charge. The administrator may also view current or active trucks and ground pilots at each port or network node and further, may submit pre-trip and post-trip inspection reports.

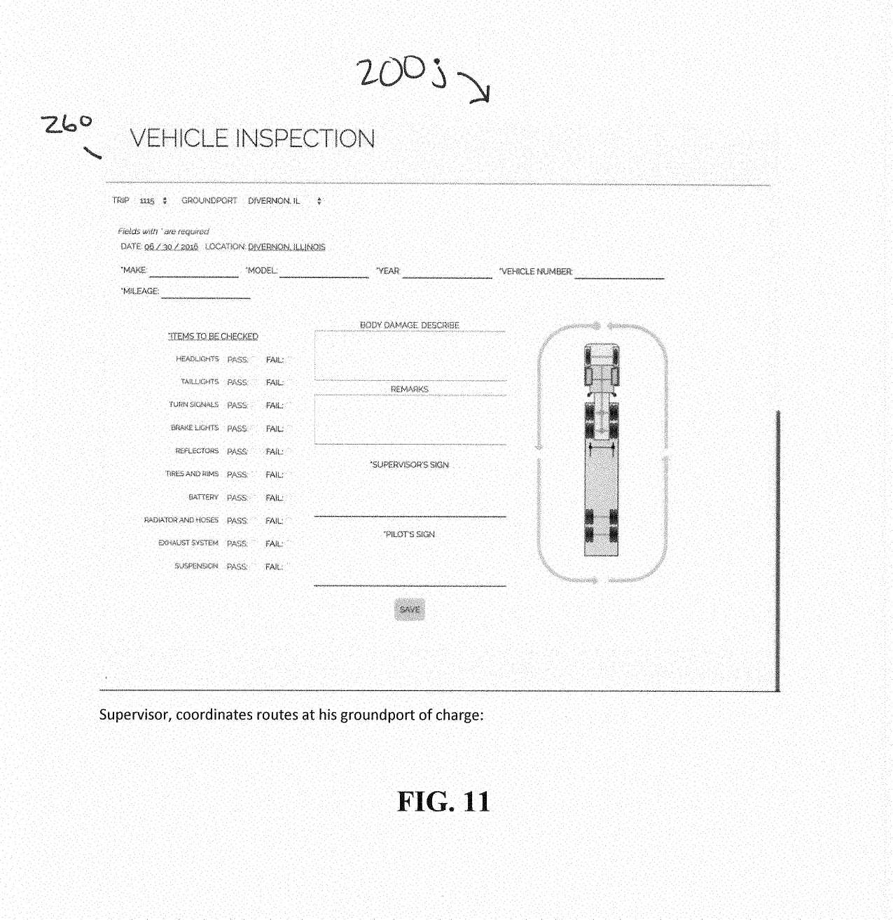

FIG. 11 is a screen shot of suitable for such an inspection report 260 presented on graphical user interface 200j.

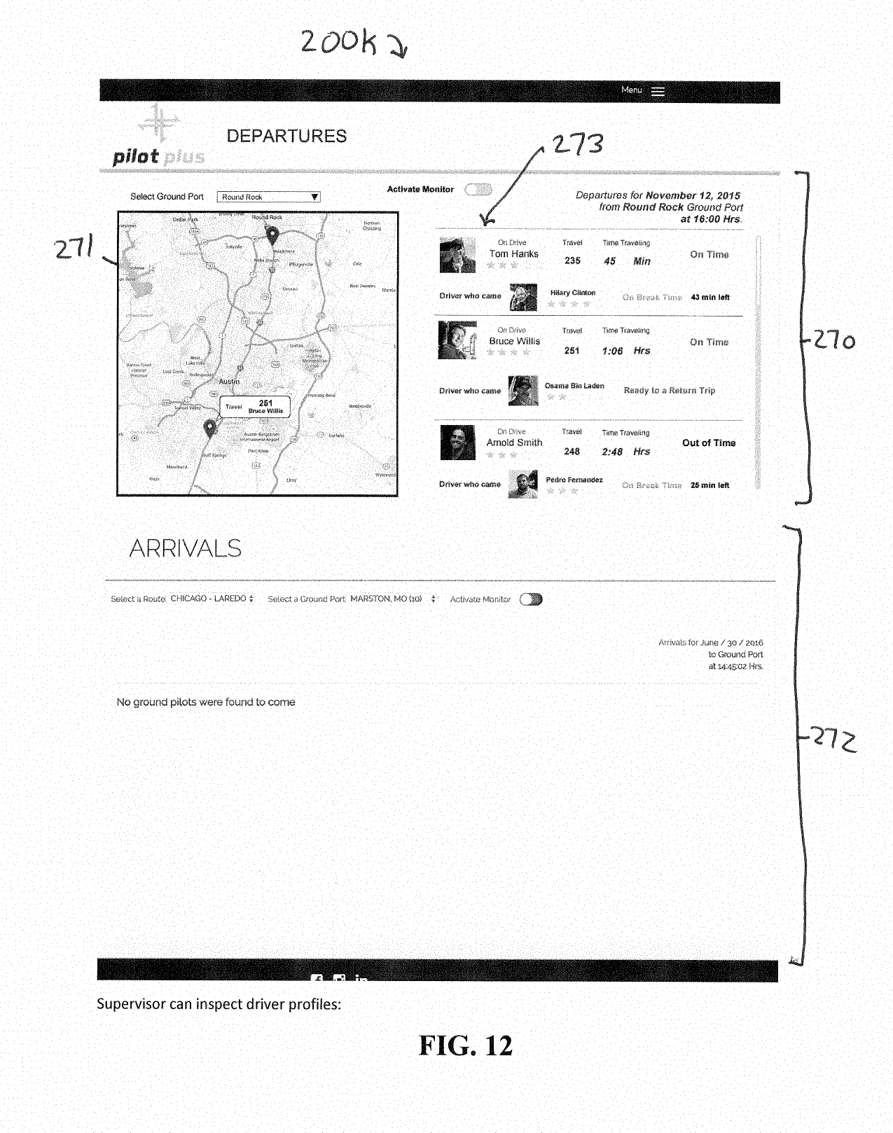

FIGS. 12-15 depict additional graphical user interfaces for use by an administrator/supervisor. FIG. 12 depicts, in particular, graphical user interface 200k providing listings of departures information 270 and arrivals information 272 from a selected ground port, Round Rock in the example. Graphical user interface 200k may present information 273 on the drivers that departed from the ground port over a certain period, and also those drivers who arrived at the ground port. Graphical user interface 200k may present the status and availability information on those “arrived” drivers. Graphical user interface 200k may allow for selection and presentation of arrivals information 272, such as by allowing an administrator to select a route and ground port to determine if any arrivals are associated with that route and ground port, including active delivery assets (e.g., ground pilots and trucks).

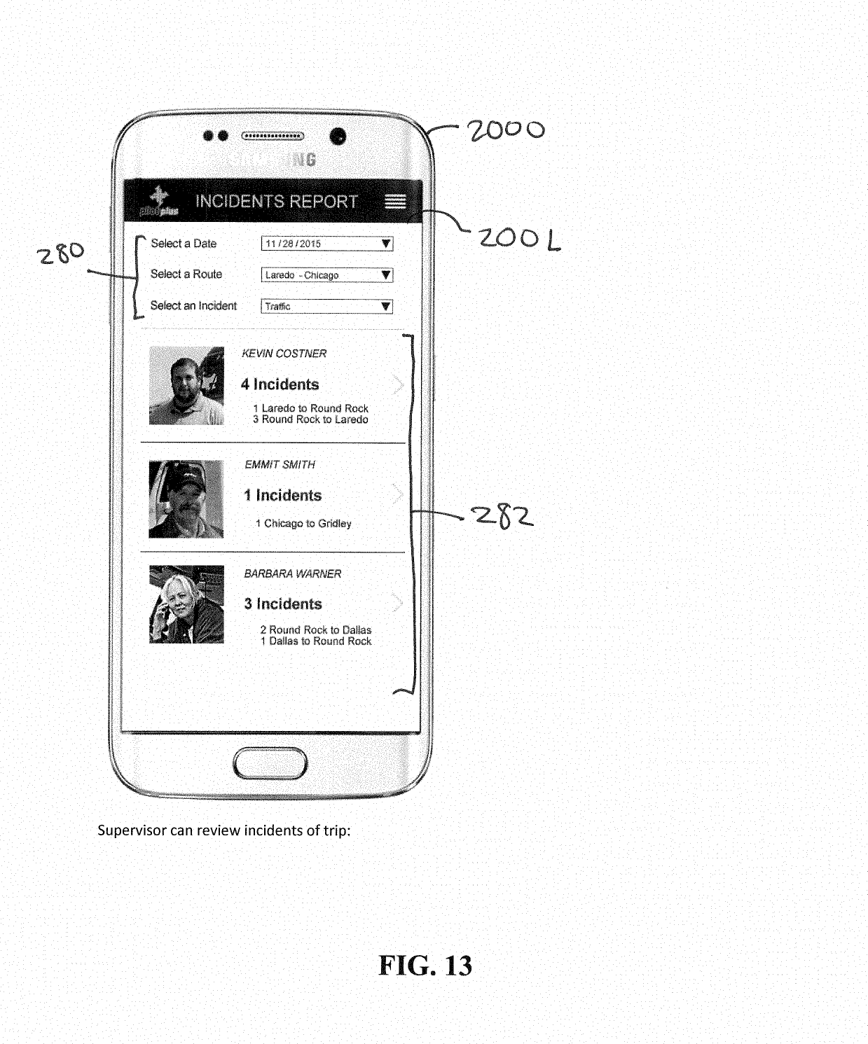

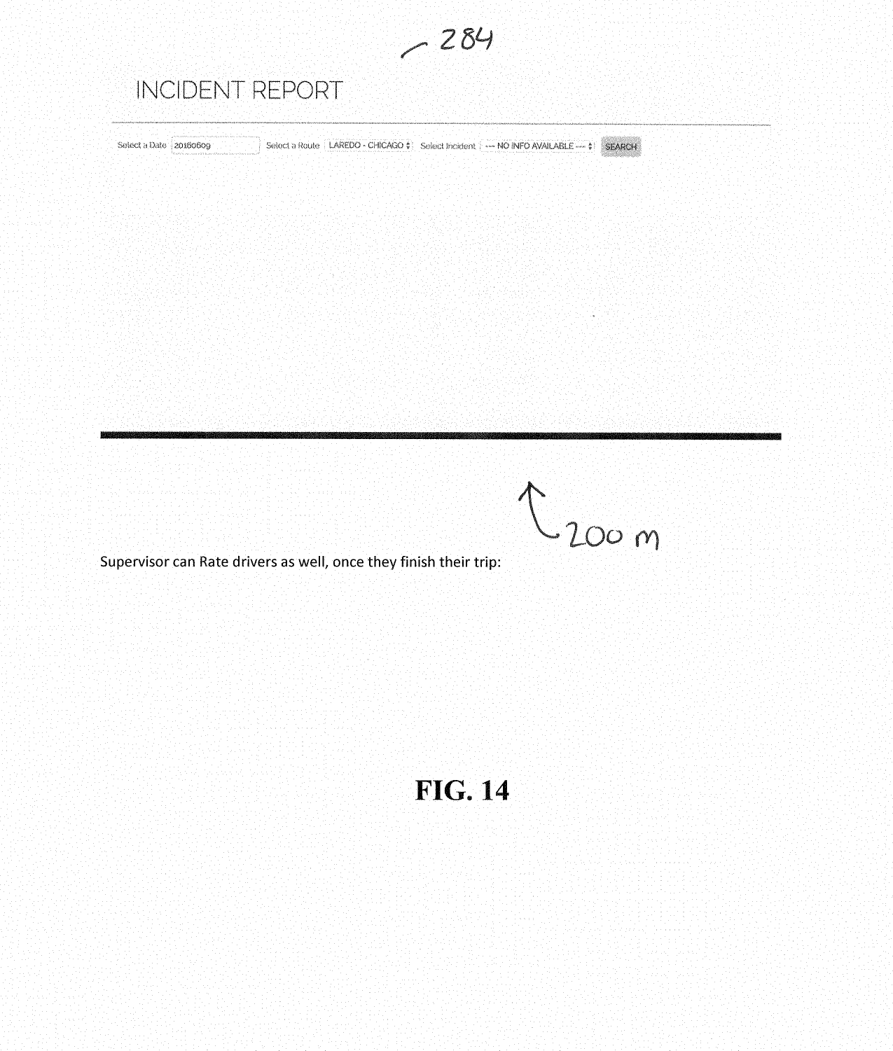

FIGS. 13-15 show exemplary application pages designed for use by the administrator/supervisor using the central computing station 2000. FIG. 13 illustrates graphical user interface 2001, which allows the administrator to review specific types of incidents on a specific route or stage, and, in this case, on an active client delivery service request on that query date. For example, the administrator may select a date, route, and incident, resulting in the administrative graphical user interface presenting ground pilots associated with the selected date, route, and incident. The graphical user interface 2001 may present the number of incidents, and locations of the incidents for each ground pilot. The administrator may select a particular ground pilot to view further details regarding the incidents. For example, FIG. 14 depicts graphical user interface 200m, presenting incident report 284.

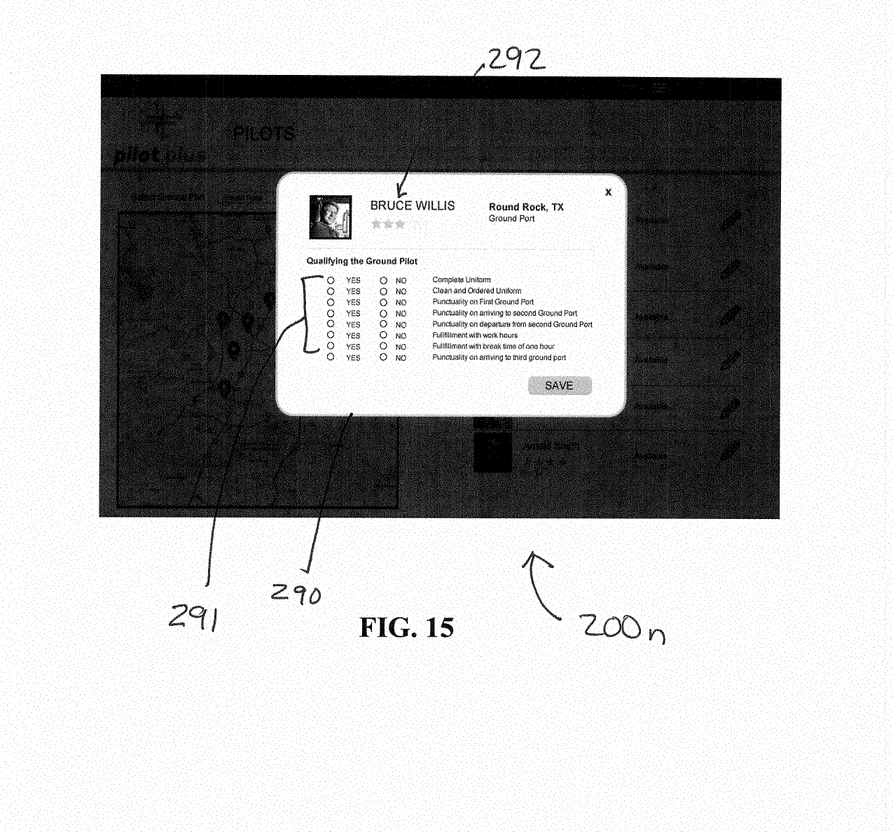

FIG. 15 depicts an exemplary graphical user interface 200n designed for use by the administrator to rate and/or review ground pilots, such as after satisfaction or fulfillment of a client delivery service request or a stage thereof. The administrator may input information by answering questions 291 regarding a ground pilot 292 within a rating window 290. The input information then becomes historical information for storage and retrieval on the computer network.

The following illustrates an exemplary method of managing a ground delivery request(s) in accordance with the present disclosure, from the perspective of, and specific to, different principals or actors:

Exemplary Ground Pilot Interaction With System of Managing a Ground Delivery Service Request

Ground Pilot:
Truck drivers applies via graphical user interface
Truck driver is sent to third party company for background verification
If truck driver is approved, truck driver is scheduled for an onsite interview, such as at a ground port facility
If truck driver is approved, truck driver becomes a ground pilot (e.g., hired by a third party company)
Ground pilot is provided a phone and access to the mobile software application in order to select available driving times and dates
The mobile application algorithm matches the ground pilot selected options with available trucks and assigns the ground pilot available work schedules
The ground pilot submits weekly/monthly schedules (optional, as the ground pilot can schedule on a day-to-day basis)
The ground pilot arrive at ground port on an assigned date and time
The ground pilot checks-in, and puts on a uniform (e.g., a professional uniform)
The ground pilot activates the mobile app on the mobile computing station
The ground pilot fulfills pre-check inspection with the mobile app and a supervisor/administrator
The trip is activated, such as within the mobile app
The ground pilot drives to the next ground port destination on the delivery route
If at any point during the drive, an incident happens, the ground pilot reports the incident using the incident tab on the graphical user interface
If an accident is present, the ground pilot must comply with the following:
   i. Rests for 30/60 minutes; and
   ii. Drive back to the origin; or, if the ground pilot has reached the allowable driving limit for that day another ground pilot from the point of origin may drive a vehicle to pick the ground pilot up
The ground pilot presents to supervisor/administrator, and starts a post-check inspection
The ground pilot must comply with all Electronic Logging Device mandates, and shall register any stops along the way (pit stops, traffic, flat tire, inspections, etc.)
The ground pilot must present to an officer at an inspection, the E-log when asked, and shared via email or Bluetooth, or present it on screen, or via whatever available form of presentation that the officer requests
Once finished, the ground pilot logs out of their account on the mobile application via the graphical user interface

Exemplary Client Interaction With System of Managing a Ground Delivery Service Request
A contract is signed
The client is assigned a username and password
The client logs into the portal (accessing the GUI)
The client registers trips on the portal
The client submits service request in the port
Client trips are matched with available times
Trips are assigned ground pilots
Clients can select current ground pilots, or select new ones (e.g., depending on cost)
Method of payment is presented
Client pays
Client is invoiced
Client can track delivery trucks via the graphical user interface, view historical data regarding prior deliveries, and view other available information, all via the client graphical user interface

Exemplary Administrator\ Supervisor Interaction With System of Managing a Ground Delivery Service Request
The administrator can view, manage, and track all of the active users in platform

Other aspects of the GUIs

In some aspects, the administrative graphical user interface presents a roster of ground pilots, and is configured to allow selection of a ground pilot from the roster of ground pilots for delivery of a customer package.

The administrative graphical user interface may presents a page allowing the tracking and viewing of the location of each delivery vehicle, and may present a status of all customer package deliveries.

The administrative graphical user interface may present a vehicle inspection report associated with each delivery vehicle, an incident report associated with each delivery vehicle or ground pilot thereof, or combinations thereof.

The administrative graphical user interface may present a page configured to allow input of reviews of ground pilots, ratings of ground pilots, or combinations thereof.

In some aspects, the ground pilot graphical user interface presents a page configured to allow input of ground pilot availability schedules. The page is configured to allow input of ground pilot availability schedules, and is configured to allow selection of: when a ground pilot is available for piloting delivery vehicles, which point or points a ground pilot is available to deliver packages to, which point or points a ground pilot is available to deliver packages from, or combinations thereof.

The ground pilot graphical user interface may presents a page configured to allow input of incident reports.

The ground pilot graphical user interface may presents a page displaying an electronic log associated with a delivery vehicle, and the administrative graphical user interface may present a page displaying the electronic log. The ground pilot graphical user interface may be configured to allow sharing of the electronic log.

The ground pilot graphical user interface may present a page configured to allow input and upload of vehicle inspection reports, and the administrative graphical user interface may be configured to present uploaded vehicle inspection reports. The vehicle inspection reports may be viewable on the client graphical user interface.

In some aspects, the client graphical user interface presents a page configured to allow selection of a particular ground pilot for customer package delivery. The client graphical user interface may present a page configured to allow input of reviews of ground pilots, ratings of ground pilots, or combinations thereof.

The graphical user interfaces disclosed herein provide for coordinated communication and monitoring of the delivery process by administrators of the delivery service, ground pilots of the delivery service, and clients (e.g., truck delivery companies) of the delivery service, allowing the clients to fulfill their customer's delivery orders. In some such aspects, the truck delivery companies provide the delivery trucks loaded with the customer packages, and the deliver service provides the ground pilots to drive the delivery vehicles, defines the delivery routes, and monitors/oversees the delivery process.

Additional Aspects

Some aspects of the systems and methods disclosed herein include utilizing asset tracking technology, fleet management, fuel control, GPS monitoring, real-time monitoring via cameras, video recording via the mobile app, and other sensor technologies. Some aspects of the systems and methods disclosed herein include utilizing anti jamming technologies, which may be used in certain jurisdictions, such as Mexico.

The foregoing description has been presented for purposes of illustration and description of preferred aspects. This description is not intended to limit associated concepts to the various systems, apparatus, structures, processes, and methods specifically described herein. For example, aspects of the processes and equipment illustrated by the Figures and discussed above may be employed or prove suitable for use to satisfy other route-dependent service, and\or other logistics challenges. The aspects described and illustrated herein are further intended to explain the best and preferred modes for practicing the system and methods, and to enable others skilled in the art to utilize same and other aspects and with various modifications required by the particular applications or uses of the present disclosure. Conversely, the system configuration and processes illustrated in the Figures may be changed, without departing from the spirit of the disclosure. Furthermore, the system configuration may be employed with other logistical processes or objectives different from that described in the preferred aspects. Such variations will become apparent to one skilled in the relevant consumer products or dental, upon provision of the present disclosure. Consequently, variations and modifications commensurate with the above teachings, and the skill and knowledge of the relevant art, are within the scope of the present disclosure. The aspects described and illustrated herein are further intended to explain the best and preferred modes for practice, and to enable others skilled in the art to utilize aspects of the disclosure and other aspects and with various modifications required by the particular applications or uses contemplated.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A computer implemented method for directing a delivery service, the method comprising:
providing a computing network including a central computing station associated with and configured for operation by an administrator of the delivery service;
operating a system of communication between the central computing station, a plurality of mobile computing stations, and at least one client computer utilizing the computer network, including presenting graphical user interfaces onto each of the plurality of mobile computing stations, the central computing station, and the at least one client computer;
establishing a network of ground ports, wherein each ground port is a physical facility, and storing the locations of each ground port on the computer network;
establishing a roster of ground pilots, wherein each ground pilot is associated with at least one of the ground ports, and storing the roster of ground pilots on the computer network, wherein each mobile computing station is associated with and configured for operation by one of the ground pilots;
receiving requests on the central computing station from the at least one client computer to pilot delivery vehicles loaded with customer packages, wherein each customer package is to be delivered from an originating point to a destination point associated with that customer package, and wherein each client computer is associated with a client submitting a request to piloting of a delivery vehicle;
for each delivery vehicle:
using computer instructions stored on the computing network to determine multiple increments of a distance between the originating point and the destination point of that delivery vehicle, wherein each increment is defined by two pre-existing ground ports of the established network of ground ports;
using computer instructions stored on the computing network to select a ground pilot from the roster of ground pilots to pilot that delivery vehicle between two selected ground ports, wherein the ground pilot is selected based upon that ground pilot's association with at least one of the two selected ground ports; and
using computer instructions stored on the computing network to direct the selected ground pilot, via the graphical user interface on that ground pilot's mobile computing station, to pilot that delivery vehicle between two selected ground ports;
wherein a different ground pilot is selected and directed for each increment until the delivery vehicle arrives at the destination point.

19. The method of claim 18, further comprising using a scheduling algorithm stored on the computer network to determine a logistical delivery schedule to coordinate the delivery vehicles.

20. The method of claim 19, wherein the scheduling algorithm coordinates each delivery vehicle with at least one additional delivery vehicle.

21. The method of claim 20, wherein the scheduling algorithm coordinates the delivery of a first customer package from a first originating point to a first destination point with delivery of the at least one additional customer package from a second originating point to the first originating point, wherein the second originating point is the same as or different than the first destination point.

22. The method of claim 20, wherein the scheduling algorithm coordinates the delivery of each customer package with delivery of at least one additional customer package such that each ground pilot is returned to that ground pilot's originating point on at least one additional delivery vehicle.

23. The method of claim 19, further compromising receiving and storing ground pilot availability schedules on the computer network from the plurality of mobile computing stations, and determining the at least two ground ports of each increment based upon the stored ground pilot availability schedules, including ground pilot availability to drive from a first ground port of the at least two ground ports to a second point of the at least two ground ports.

24. The method of claim 18, wherein the distance of each increment is a predetermined distance that is an increment of the distance between the originating point and the destination point.

25. The method of claim 19, wherein a first ground pilot is selected and directed to pilot a first delivery vehicle from point A to point B, in advancement of a first customer package from a first originating point toward a first destination point; and a second ground pilot is selected and directed to pilot the delivery vehicle from the point B toward the first destination point, in advancement of the first customer package from the first originating point toward the first destination point.

26. The method of claim 25, further comprising selecting a second delivery vehicle to transport the first ground pilot from point B back to point A using the logistical delivery schedule, wherein the first ground pilot pilots the second delivery vehicle from point B back to point A or wherein a third ground pilot pilots the second delivery vehicle from point B back to point A, and wherein the second delivery vehicle contains a second customer package, thereby advancing the second customer package from point B toward a second destination point associated with the second customer package.

27. (canceled)

28. (canceled)

29. (canceled)

30. (canceled)

31. (canceled)

32. (canceled)

33. The method of claim 18, wherein the graphical user interface on each of the plurality of mobile computers is configured to allow the ground pilots to form an availability schedule by selecting when they are available for piloting delivery vehicles, which point or points they are available to deliver packages to, which point or points they are available to deliver packages from, or combinations thereof, wherein the availability schedules are stored on the computer network.

34. The method of claim 18, wherein the graphical user interface on each of the plurality of mobile computers is configured to allow the ground pilots to report incidents to the 35, and wherein the incident reports are stored on the computer network.

35. (canceled)

36. The method of claim 18, wherein the graphical user interface on each of the plurality of mobile computers is configured to present an electronic log associated with the delivery vehicle, wherein the electronic log is stored on the computer network and is viewable by the administrator via the graphical user interface of the central computing station, wherein the graphical user interface on each of the plurality of mobile computers is configured to allow sharing of the electronic logs.

37. (canceled)

38. The method of claim 18, wherein the graphical user interface on the central computing station is configured to all the administrator to track all delivery vehicles, mobile computing stations, or combinations thereof in communication with the computer network, and wherein the graphical user interface on the central computing station is configured to all the administrator to track a status of all package deliveries.

39. (canceled)

40. (canceled)

41. (canceled)

42. The method of claim 18, wherein, after each increment that each delivery vehicle is piloted through, a vehicle inspection is performed on that delivery vehicle, wherein the graphical user interface on each mobile computing station is configured to allow the ground pilot to complete and upload a vehicle inspection report onto the computer network, and wherein the graphical user interface on the central computing station is configured to present to each uploaded vehicle inspection report.

43. (canceled)

44. A computer aided system for directing a delivery service, the system comprising:
a computing network including a central computing station associated with and configured for operation by an administrator of the delivery service;
a network of ground ports, wherein each ground port is physical facility, and wherein the locations of each ground port are stored on the computer network;
a roster of ground pilots, wherein each ground pilot is associated with at least one of the ground ports, and wherein the roster of ground pilots is stored on the computer network;
a plurality of mobile computing stations, wherein each mobile computing station is associated with and configured for operation by one of the ground pilots, and wherein each mobile computing station is in communication with the central computing station via the computer network;
wherein the central computing station is configured to receive and store requests to pilot delivery vehicles loaded with customer packages from client computers in communication with the central computing station via the computer network, wherein each customer package is to be delivered from an originating point to a destination point associated with that customer package;
computer instructions on the computer network to present graphical user interfaces onto each of the plurality of mobile computing stations, the central computing station, and the client computers;
computer instructions stored on the computer network to determine multiple increments of a distance between the originating point and the destination point for each delivery vehicle, wherein each increment is defined by two pre-existing ground ports of the established network of ground ports;
computer instructions stored on the computer network to select a ground pilot from the roster of ground pilots to pilot a delivery vehicle between two selected ground ports, wherein the ground pilot is selected based upon that ground pilot's association with at least one of the two selected ground ports; and
computer instructions stored on the computer network to direct the selected ground pilot, via the graphical user interface on that ground pilot's mobile computing station, to pilot a delivery vehicle between two selected ground ports;
wherein a different ground pilot is selected and directed for each increment until the customer package contained within the delivery vehicle arrives at the destination point.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. The method of claim 19, wherein the scheduling algorithm is configured to dynamically modify the logistical delivery schedules.

87. The method of claim 18, further comprising providing for real-time visualization of the delivery process via cameras on the delivery vehicle, the real-time visualization viewable on graphical user interfaces.

88. (canceled)

89. A method of directing the movement of a delivery vehicle from an origination point to a destination point, the method comprising:
establishing a network of ground ports, wherein each ground port is a physical facility;
establishing a roster of ground pilots, wherein each ground pilot is associated with at least one of the ground ports;
receiving requests to pilot delivery vehicles loaded with customer packages, wherein each delivery vehicle is to be piloted from an originating point to a destination point associated with that delivery vehicle; and
for each delivery vehicle:
determining multiple increments of a distance between the originating point and the destination point, wherein each increment is defined by two pre-existing ground ports of the established network of ground ports; and
selecting and directing a ground pilot from the roster of ground pilots to pilot that delivery vehicle between two selected ground ports, wherein the ground pilot is selected based upon that ground pilot's association with at least one of the two selected ground ports, and wherein a different ground pilot is selected for each increment until the delivery vehicle arrives at the destination point;
wherein the delivery route of each delivery vehicle is coordinated with the delivery route of at least one additional delivery vehicle.

90. The method of claim 89, wherein a scheduling algorithm is used to coordinate multiple delivery routes, such that each ground pilot is transported on a delivery vehicle, back along an increment, to that ground pilots starting ground port.

91. The method of claim 90, wherein the scheduling algorithm is optimized for the ground pilots, such that each ground pilot travels in delivery vehicles for no more than 500 miles in one day or for no more than 8 hours in one day.
